(19) United States
(12) Patent Application Publication
(10) Pub. No.: US 2016/0008778 A1
(43) Pub. Date: Jan. 14, 2016

(54) DEVICES AND METHODS FOR FORMING RELATIVELY MONODISPERSE DROPLETS

(71) Applicant: PRESIDENT AND FELLOWS OF HARVARD COLLEGE, Cambridge, MA (US)

(72) Inventors: David A. Weitz, Bolton, MA (US); Esther Amstad, Camridge, MA (US); Ralph Alexander Sperling, Eltville (DE)

(21) Appl. No.: 14/767,798

(22) PCT Filed: Mar. 5, 2014
(86) PCT No.: PCT/US14/20525

§ 371 Date: Aug. 13, 2015

Related U.S. Application Data
(60) Provisional application No. 61/773,604, filed on Mar. 6, 2013.

(51) Int. Cl. B01F 13/00; B01F 5/06; B01F 3/08

(52) U.S. Cl. CPC B01F 13/0069; B01F 3/0807; B01F 5/0602; B01F 5/0661

(57) ABSTRACT

Devices and methods for dividing droplets are generally described. In some embodiments, an article may comprise a fluidic channel comprising an array of obstructions. In certain embodiments, the arrangement of obstructions in the array may affect the flow path of fluid in the channel. For example, the array of obstructions may be used to convert a polydisperse population of droplets into a relatively monodisperse population of droplets. Passing a polydisperse population of droplets through the array may result in the division of droplets such that the population of droplets exiting the array has a narrower distribution in the characteristic dimensions of the droplets. The arrangement of obstructions in the array may allow for high-throughput production of a substantially monodisperse population of droplets in some cases. In some embodiments, the population of droplets exiting the array may be converted into particles.

### RELATED APPLICATIONS

This application claims the benefit of U.S. Provisional Patent Application Ser. No. 61/773,604, filed Mar. 6, 2013, entitled “Devices and Methods for Forming Relatively Mondisperse Droplets,” incorporated herein by reference in its entirety.

### TECHNICAL FIELD

Devices and methods for the division of fluid droplets are generally described.

### BACKGROUND

The manipulation of fluids to form fluid streams of desired configuration, discontinuous fluid streams, droplets, particles, dispersions, etc., for purposes of fluid delivery, product manufacture, analysis, and the like, is a relatively well-studied art. Examples of methods of producing droplets in a microfluidic system include the use of T-junctions or flow-focusing techniques. However, such techniques typically work at relatively slow laminar or “dripping” conditions, and in some applications, faster rates of droplet production are needed, for instance, to produce larger numbers of droplets.

Some conventional fluidic devices try to increase production by connecting more than one fluidic device in order to parallelize particle formation. However, parallelization of thousands or even millions of fluidic devices may be necessary for some applications, e.g., for industrial uses. Thus, the throughput of fluidic devices has to be significantly increased before their industrialization becomes feasible. Moreover, the failure of even a single fluidic device in an array of thousands of fluidic devices can result in higher polydispersity. Accordingly, improvements in droplet production systems and methods are needed.

### SUMMARY

Devices and methods for the division of fluid droplets are generally described. The subject matter of the present invention involves, in some cases, interrelated products, alternative solutions to a particular problem, and/or a plurality of different uses of one or more devices and/or articles.

In one aspect, the present invention is generally directed to an article. In accordance with one set of embodiments, the article comprises a microfluidic channel comprising a two-dimensional array of obstructions therein, arranged in a plurality of rows of substantially regularly-spaced obstructions, the rows arranged substantially orthogonal to a direction of average fluid flow through the microfluidic channel. In some cases, at least some of the rows of substantially regularly-spaced obstructions are offset relative to an adjacent row of substantially regularly-spaced obstructions.

The article, in another set of embodiments, comprises a microfluidic channel comprising a two-dimensional array of obstructions therein, arranged in a plurality of rows of obstructions, the rows arranged substantially orthogonal to a direction of average fluid flow through the microfluidic channel. In certain cases, at least about 90% of imaginary lines drawn through the array of obstructions in the direction of average fluid flow through the microfluidic channel intersects obstructions of at least about 40% of the rows of obstructions forming the array.

Yet another set of embodiments is generally directed to an article comprising a microfluidic channel comprising an array of obstructions therein, arranged such that no flow path of fluid from upstream entering the array of obstructions exits downstream of the array without at least five changes in direction.

The present invention, in another aspect, is generally directed to a method. In one set of embodiments, the method comprises acts of providing a two-dimensional array of obstructions contained within a microfluidic channel, and passing a plurality of droplets through the array of obstructions to divide at least about 50% of the droplets to form a plurality of divided droplets. In some instances, the average distance between an obstruction and the next nearest obstruction is less than about 1 mm.

The method, according to another set of embodiments includes an act of applying shear forces to a plurality of droplets by passing the plurality of droplets through a two-dimensional array of obstructions such that the droplets are divided to form a plurality of divided droplets. In some embodiments, the plurality of divided droplets has a distribution in characteristic dimension such that no more than about 5% of the divided droplets have a characteristic dimension greater than about 120% or less than about 80% of the average characteristic dimension of the plurality of divided droplets.

Still another set of embodiments is generally directed to a method comprising passing a droplet through a two-dimensional array of obstructions contained within a microfluidic channel to divide the droplet to form a plurality of divided droplets.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 illustrates a schematic of a device of one embodiment of the present invention.

FIGS. 2A-G illustrate arrays of a variety of obstructions and droplet division according to certain embodiments.

FIG. 3 illustrates parallelization of devices, according to one embodiment.

FIGS. 4A-B illustrate a graph of droplet size versus capillary number and interstitial volume according to certain embodiments.

FIGS. 5A-C illustrate graphs of volume percent of dispersed phase, droplet size, and coefficient of variation versus interstitial volume, according to one set of embodiments.

FIG. 6 illustrates the distribution in characteristic dimension of droplets based on obstruction geometry, according to one set of embodiments.

FIGS. 7A-F illustrate droplet division for different obstruction geometries, according to certain embodiments.

FIGS. 8A-E illustrate droplet division for different aspect ratios, according to certain embodiments.

FIGS. 9A-B illustrate particles formed according to one set of embodiments.

FIGS. 10A-H illustrate droplet division for different aspect ratios and graphs of the average droplet diameter versus aspect ratio, according to certain embodiments.

FIGS. 11A-F illustrate particles formed according to one set of embodiments.

FIG. 12 illustrates a graph of droplet diameter versus fluid velocity, according to certain embodiments.

FIG. 13 illustrates particles formed according to one set of embodiments.

FIG. 14 illustrates graphs of droplet diameter versus the number of rows, according to one set of embodiments.

### DETAILED DESCRIPTION

Devices and methods for dividing droplets are generally described. In some embodiments, an article may comprise a fluidic channel comprising an array of obstructions. In certain embodiments, the arrangement of obstructions in the array may affect the flow path of fluid in the channel. For example, the array of obstructions may be used to convert a polydisperse population of droplets into a relatively monodisperse population of droplets. Passing a polydisperse population of droplets through the array may result in the division of droplets such that the population of droplets exiting the array has a smaller characteristic dimension and/or narrower distribution in the characteristic dimensions of the droplets. The arrangement of obstructions in the array may allow for high-throughput production of a substantially monodisperse population of droplets in some cases. In some embodiments, the population of droplets exiting the array may be converted into particles.

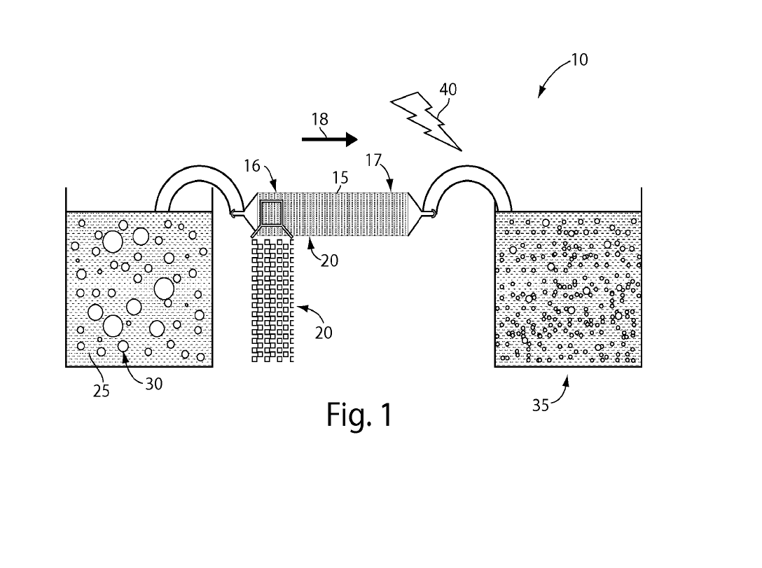

One aspect of the present invention is generally directed to devices and methods for dividing droplets. One non-limiting example is illustrated in FIG. 1. As illustratively shown in FIG. 1, a fluidic device 10 may comprise a channel 15 containing an array of obstructions 20 (the inset shows a blown-up region of the array for clarity). Fluid 25 entering the channel may flow from upstream 16 to downstream 17 in the direction of arrow 18 (representing the average direction of fluid flow in channel 15). The fluidic device may be arranged such that fluid entering the channel passes through the array of obstructions before exiting the channel. In certain embodiments, the fluid entering the channel may comprise droplets, e.g., droplets 30 in FIG. 1. The droplets within fluid 25 may be produced via any suitable technique, such as an emulsion process (e.g., bulk emulsification), such that fluidic droplets are dispersed in a continuous fluid phase. Typically, the droplets are polydisperse. In some embodiments, the droplets may be formed on the device upstream of the array.

In some embodiments, the fluidic device may be arranged such that a droplet entering the array may exit as divided droplets, e.g., with a characteristic dimension dictated by the system (e.g., the configuration of the device and/or properties of the fluids). For instance, in some embodiments, the droplet may be divided by the obstructions in the array into two or more divided droplets. The divided droplets may also be divided in some cases. This division process may continue until all divided droplets originating from the droplet have roughly the specific characteristic dimension, thereby producing relatively monodisperse droplets. Thus, as illustratively shown in FIG. 1, the fluidic device may be used to convert a population of polydisperse droplets 30 into a population of relatively monodisperse droplets 35.

In certain embodiments, a relatively large number of droplets can enter, occupy, and/or exit the array at substantially the same time, such that droplets with specific characteristic dimension can be produced with high throughput. Thus, although the division of a single droplet was discussed above, this is by way of clarity, and in other embodiments, multiple droplets may simultaneously progress through the array of obstructions. In addition, in some instances, a droplet entering or exiting the array may undergo additional processes before and/or after passing through the array of obstructions. For example, as shown in FIG. 1, droplets comprising monomer and photo-initiator may be exposed to ultraviolet light to induce photo-polymerization within the droplets before the droplets exit the channel.

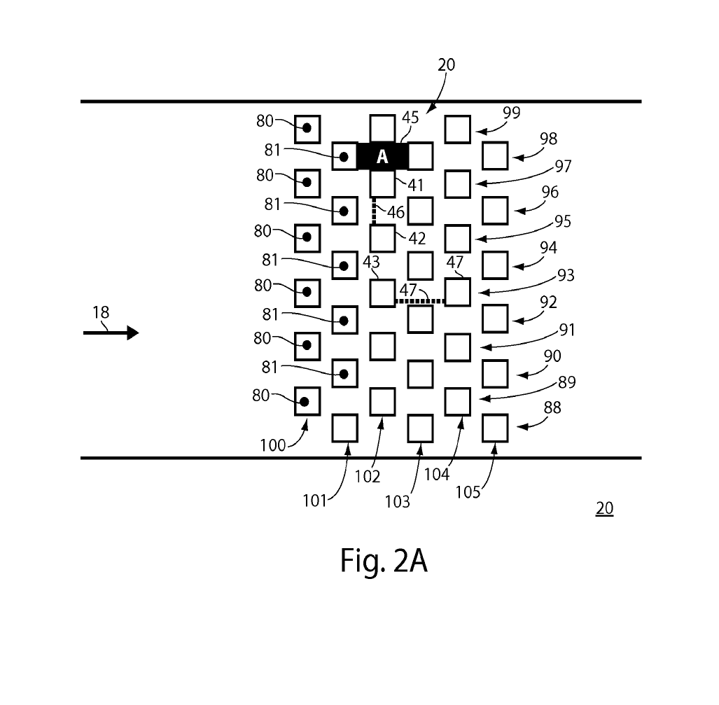

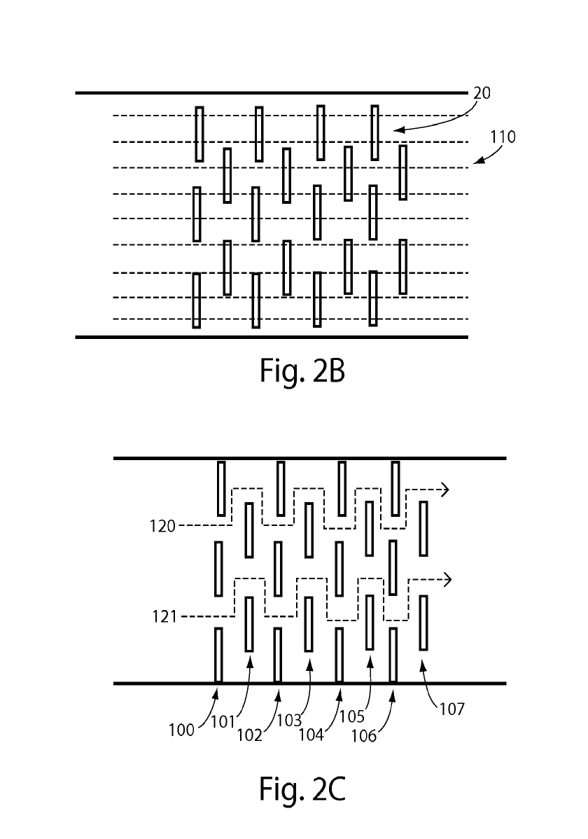

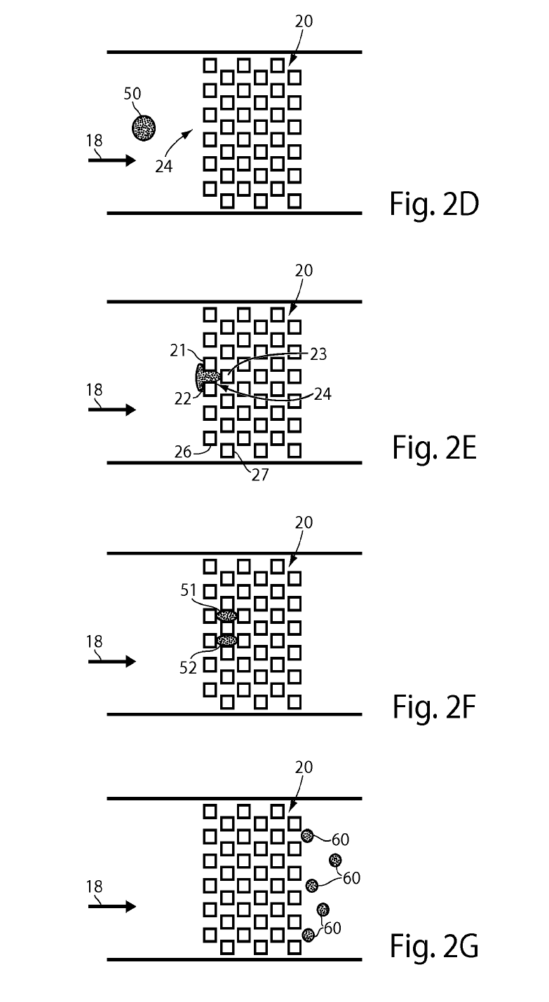

As mentioned above, a channel may contain obstructions arranged in an array. In one example, a microfluidic channel may comprise a two-dimensional array of obstructions therein as shown in FIG. 2A. The obstructions may be regularly or irregularly positioned within the channel; for example, the obstructions may be arrayed in a plurality of rows 100, 101, 102, 103, 104, and 105 as shown in FIG. 2A. The obstructions may be substantially regularly spaced in the plurality of rows, or some or all of the rows may contain an irregular spacing of obstructions. In certain embodiments, the rows may be arranged to be substantially orthogonal to the average direction of fluid flow as shown in FIG. 2A, or otherwise positioned at a non-zero angle with respect to the average direction of fluid flow 18. For example, the rows may also be aligned such that the angle between the row and the average direction of fluid flow is between about 45° and about 135°, between about 80° and about 100°, or between 85° and about 95°, etc.

In some embodiments, the centers of the obstructions in at least some of the rows may be offset relative to the centers of the obstructions in an adjacent row (i.e., a next nearest row). For example, as shown in FIG. 2, the centers of the obstructions 80 in a first row 100 may be offset from the centers of the obstructions 81 in a second row 101, i.e., offset relative to the direction of average fluid flow within the channel. In one set of embodiments, the obstructions may be offset such that the midpoints between the centers of two obstructions of a first row 100 is aligned with the center of an obstruction 81 in an adjacent second row, as is shown in FIG. 2A. In some cases, all of the rows of obstructions in the array may be offset relative to an adjacent row of obstructions, e.g., as is shown in FIG. 2A with rows 100, 102, and 104 being offset relative to rows 101 and 103. In addition, in embodiments in which a row is aligned with another row, the array may be described as having columns e.g., as is shown in FIG. 2A with columns 88, 89, 90, 91, 92, 93, 94, 95, 96, 97, 98, and 99, i.e., such that the columns are defined by obstructions located in every other row. However, it should be understood that the array in FIG. 2A is by way of example only, and in other embodiments, there may be more or fewer numbers of obstructions, row, and/or columns, and/or the obstructions themselves may also have a variety of different shapes. In addition, in some cases, the arrangement of obstructions may be more irregular than is depicted in FIG. 2A, or the obstructions may not be perfectly aligned or exhibit different types of spacings or offsets in some cases.

In some embodiments, the obstructions in the array may be positioned relatively close to each other. For instance, the obstructions in the array may be arranged such that at least about 70% (e.g., at least about 80%, at least about 90%, at least about 95%, at least about 98%, about 100%) of imaginary lines drawn through the array of obstructions in the direction of average fluid flow through the channel intersect obstructions of at least about 20% (e.g., at least about 30%, at least about 40%, at least about 50%, at least about 60%) of the rows of obstructions forming the array. For example, as illustratively shown in FIG. 2B, a series of imaginary lines 110 may be drawn through the array 20 in the average direction of fluid flow 18. For instance, as shown in FIG. 2B, at least about 90% of imaginary lines drawn through the array of obstructions in the direction of average fluid flow through the channel may intersect obstructions of at least about 40% of the rows of obstructions forming the array.

In addition, in certain embodiments, the obstructions may be arranged in the array such that no flow path of fluid from upstream entering the array of obstructions exits downstream of the array without at least five changes in direction (e.g., at least 10, at least 20, at least 30, at least 40, at least 50, at least 60, at least 70, at least 80, at least 90, etc. changes in direction). This may be understood with reference to FIG. 2C. As shown in FIG. 2C, flow paths 120 and 121 entering the array through the first row 100 may change direction upon encountering obstructions in the second row 101, since flow path 120 cannot continue straight ahead due to the presence of the obstructions. In order to traverse the array, the various flow paths change directions as they encounter obstructions in rows 102, 103, 104,105, and 106 before exiting between obstructions in row 107. In addition, no flow path can be drawn through the array that does not require at least one change in direction (although in some cases, there may be flow paths that go around the array, as is shown in FIG. 2A).

In some embodiments, the placement of obstructions in the array may be described in terms of the average interstitial area and/or volume of the array. The average interstitial area may be defined as the area defined by the average horizontal spacing (i.e., the edge to edge distance between an obstruction and a next nearest obstruction in a row) and the average vertical spacing (i.e., the edge to edge distance between an obstruction and the next nearest obstruction in a column), as shown in FIG. 2A. For instance, in this figure, the average horizontal spacing 46 is defined by the edge to edge distance (i.e., the shortest straight line distance between the closest edges of the obstructions) between an obstruction 41 and the next nearest neighbor 42 in a row, and the average vertical spacing 47 is defined by the edge to edge distance between an obstruction 43 and the next nearest neighbor 44 in a column (note that in FIG. 2A, this measurement skips a row, e.g., extending between an obstruction in row 102 and an obstruction in row 104 while bypassing obstructions in row 103). From these measurements, the interstitial area can be calculated as the average horizontal spacing multiplied by the average vertical spacing, and the interstitial volume can be calculated as the average interstitial area multiplied by the height of the fluidic channel.

As described herein, a channel containing an array of obstructions may be used to divide droplets, e.g., as the droplets encounter various obstructions within the array. A schematic illustration of various droplet division processes, according to various embodiments of the present invention, may be seen in FIG. 2D-G as an illustrative example (however, in some embodiments, there may be multiple droplets present within the array and/or more than one of the following mechanisms may be acting together; a single droplet is shown here for clarity). As shown in FIG. 2D, a droplet 50 upstream of a two-dimensional array of obstructions 20 may flow in the average direction of fluid flow 18 toward the array. In some embodiments, the array of obstructions may affect the flow path of the droplet. For instance, as shown in FIG. 2E, droplet 50 may enter the array through a gap 24 between an obstruction 21 and a next nearest obstruction 22 in the first row of obstructions 26. The droplet may then encounter an obstruction 23 in the second row of obstructions 27. By a variety of mechanisms, as discussed below, such encounters may cause the droplet to break into two or more droplets.

The obstructions may, in some embodiments, be arrayed such that a droplet encounters a plurality of obstructions before exiting the array. For example, in traversing the array, a droplet may encounter an obstruction in at least 10%, at least 20%, at least 40%, at least 60%, or at least 80% of the rows of the array. In some embodiments, until the droplet changes its flow direction (e.g., by 90 degrees, or other angles), the droplet may be effectively “trapped,” i.e., fluid flow near the obstruction became restricted, relative to the average direction of fluid flow through the channel, by the obstructions. Such trapping may facilitate causing the droplet to break into two or more separate droplets.

For example, in certain cases, depending on the droplet volume relative to the interstitial volume, a droplet may be unable to pass by the obstruction without major alterations in the shape and/or size of the droplet. For instance, in some cases, the droplet may be squeezed against and/or pushed to both sides of the obstruction by fluid flow. In some embodiments, as shown illustratively in FIG. 2E, the encounter with the obstruction and/or the change in direction may cause the droplet to divide into divided droplets 51 and 52 that are individually more able to circumvent obstructions within the array. In other embodiments, the droplet may divide into more than two droplets, and/or the droplets may also become further divided upon encountering other obstructions, for example, to produce a population of divided droplets 60 resulting from the division of droplet 50, as is shown in FIG. 2G.

Droplet division may continue, in some embodiments, until the divided droplets have reached a certain distribution in characteristic dimension, i.e., subsequent obstructions in the array do not substantially further alter the average characteristic dimension of the droplets as they flow through the array of obstructions. The “characteristic dimension” of a droplet, as used herein, is the diameter of a perfect sphere having the same volume as the droplet. As discussed herein, in some cases, the characteristic dimension of the droplets may be controlled, at least in part, by features of the device and the ratio of the viscosities of the dispersed phase to the continuous phase.

Without wishing to be bound by any theory, it is believed that the division of a droplet may be caused by shear forces on the droplet caused by the change in direction of the droplet and/or the interaction of the droplet with the obstruction and by the pressure drop across parts of the device. It is believed that the pressure drop may be caused by increased resistance due to droplets that are trapped between obstacles. The trapped droplets may increase the pressure upstream of their locations. Once the upstream pressure exceeds the Laplace pressure, the drop may divide. In some instances, for example, droplets that are unable to pass by an obstructions without alterations in the shape may be squeezed against and pushed to both sides of the obstruction at substantially the same time by incoming fluid. As a result, the droplet may break into divided droplets that can flow around the obstruction. Thus, passing a droplet through an array of obstructions may cause shear forces to be applied to the droplet such that the droplet is divided into a plurality of droplets.

The efficiency of the droplet division process, in certain embodiments, may be dependent on various factors such as the obstruction geometry or the capillary number of the droplet. For instance, the geometry of the obstruction may prevent a droplet from circumventing the obstruction without undergoing major alterations in the shape or direction of flow of the droplet. One example of a geometrical feature that may produce this effect is the presence of a portion, as oppose to a vertex, that is aligned at approximately a 90 degree angle with the average direction of fluid flow. Such a portion would block further fluid flow and cause an alteration in the shape or direction of flow of a droplet. Rectangular and circular obstructions are examples of suitable obstructions. In some embodiments, obstruction geometries that do not trap droplets that are larger than the specific characteristic dimension dictated by features of the device, may produce a population of droplets exiting the array with higher distribution in characteristic dimension than obstruction geometries that do trap droplets that are larger than the specific characteristic dimension dictated by features of the device.

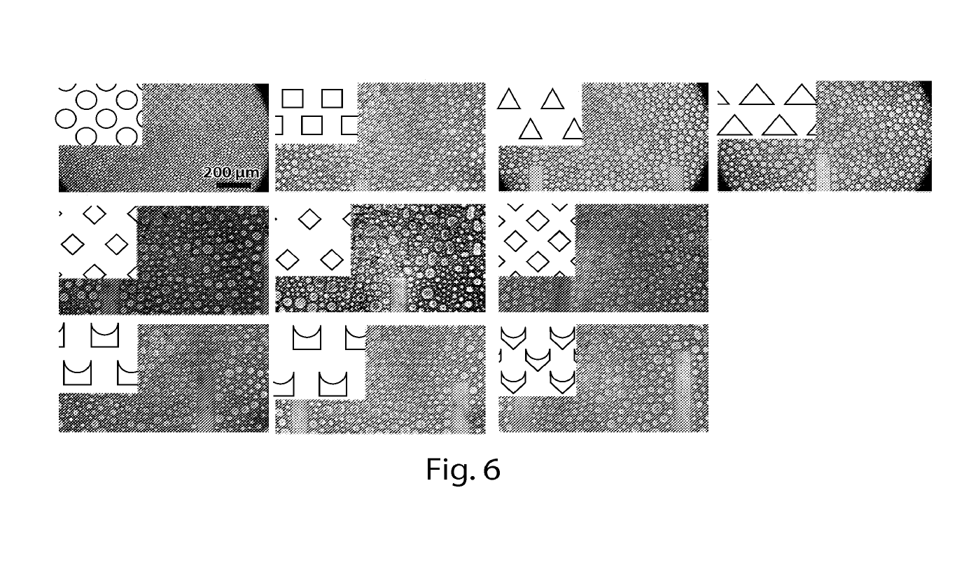

However, it should be understood that the invention is not limited to only obstructions containing 90 degree portions. Other obstruction geometries may also be used, e.g., any geometry that can cause a change in the direction of fluid flow around the obstruction. Examples include, but are not limited to, triangular obstructions with a vertex aligned with the average direction of fluid flow, diamond shaped obstructions with a vertex aligned with the average direction of fluid flow, obstructions with a semi-circular indentations in the average direction of fluid flow, irregular obstructions, etc., although in some of these cases, the ability of such obstructions to alter the average direction of fluid flow may be reduced. Examples of some of these obstructions may be seen in FIG. 6. Thus, in general, any suitable obstruction shape may be used to divide a droplet. Non-limiting examples of obstruction shapes include circular, triangular, diamond-shaped, square, rectangular, substantially semicircular, polygons with indentations, regular polygon, and irregular polygon.

In addition, in some embodiments, some of the obstructions may be positioned such that, relative to the average fluid flow within the channel, the fluid encounters a wall that is angled at about 85 degrees, about 80 degrees, about 75 degrees, about 70 degrees, about 65 degrees, about 60 degrees, etc. In addition, in some cases, an array can comprise more than one type of obstruction, e.g., including any of the geometries, shapes, or sizes discussed herein. For example, a first portion of the array may include a first geometry and a second portion of the array may include a second geometry, or obstructions having different geometries may be present in a row or in a column, etc.

In some embodiments, the capillary number may be important for controlling the efficiency of the droplet division process or the size of the droplets produced in an array of obstructions. The capillary number can be defined as:

Ca=ηq/(hwγ).

In this equation, eta (η) is the viscosity of the droplets, q the average flow rate of fluid in the channel, h the overall channel height, w the overall channel width, and gamma (γ) the surface tension of the continuous fluid flowing in the channel. In some cases, the division of a droplet may occur if the droplet has a flow that is above a threshold capillary number. The threshold may depend on various factors, such as the ratio of the viscosity of the droplet to the viscosity of the continuous phase. In general, any suitable capillary number of the droplet may be used. For instance, in some embodiments, the capillary number of the droplets flowing within a channel may be greater than or equal to about 0.001, greater than or equal to about 0.005, greater than or equal to about 0.01, greater than or equal to about 0.05, greater than or equal to about 0.1, greater than or equal to about 0.5, greater than or equal to about 1, greater than or equal to about 2, or greater than or equal to about 5. In some instance, the capillary number of the droplet may be less than about 10, less than about 5, less than about 2, less than about 1, less than about 0.5, less than about 0.1, less than about 0.05, less than about 0.01, or less than about 0.005. Combinations of the above-referenced ranges are also possible (e.g., greater than or equal to about 0.1 and less than 2). Other values of capillary number of the droplet are also possible. The capillary number may be calculated by using the equation above. The viscosity of the droplet and the surface tension may be measured using any suitable technique, e.g., using a viscometer and contact angle measurements, respectively.

As mentioned above, droplets entering the array of obstructions may exit as a plurality of droplets with a certain characteristic dimension that may be controlled, in part, by the arrangement of obstructions within the array. In some cases, the droplets exiting the array may have a narrower distribution of characteristic diameters than the droplets entering the array, or the droplets may be substantially monodisperse, in some embodiments. In one set of embodiments, the exiting droplets may have a distribution of characteristic dimension such that no more than about 20%, about 10%, or about 5% of the droplets exiting the array have a characteristic dimension greater than about 120% or less than about 80%, greater than about 115% or less than about 85%, or greater than about 110% or less than about 90% of the average of the characteristic dimension of the droplets exiting the array.

In some instances, the coefficient of variation of the characteristic dimension of the exiting droplets may be less than or equal to about 20%, less than or equal to about 15%, or less than or equal to about 10%.

The characteristic dimension of the droplets exiting the array may, in some embodiments, be relatively independent of the characteristic dimension of the droplets entering the array, e.g., in arrays that are sufficiently long such that the droplets are able to be repeatedly divided. The characteristic dimension of the droplets exiting the array may thus, in some embodiments, be dependent on factors such as the design of the fluidic channel, the design of the array, the aspect ratio of the obstructions, the capillary number of the droplets, the percent of the dispersed phase in the emulsion, or the viscosities of the fluids in the channel. In some cases, the characteristic dimension of the droplets may be controlled by device design and/or altering one or more of these properties. For instance, in certain embodiments, the characteristic dimension may be selected by designing an array of obstructions with a certain interstitial volume. In another example, the characteristic dimension any controlled by altering the capillary number of the droplet, percent of the dispersed phase of the emulsion, or the viscosities of the fluids in the channel.

In some embodiments, a plurality of droplets may be able to enter, occupy, and/or be divided by the array at substantially the same time. In some instances, the rate at which droplets exit the array of obstructions may be relatively fast (e.g., greater than or equal to about 1,000 droplets/s, greater than or equal to 5,000 droplets/s, greater than or equal to about 10,000 droplets/s, greater than or equal to about 50,000 droplets/s, greater than or equal to about 100,000 droplets/s, 300,000 droplets/s, 500,000 droplets/s, 1,000,000 droplets/s, etc.).

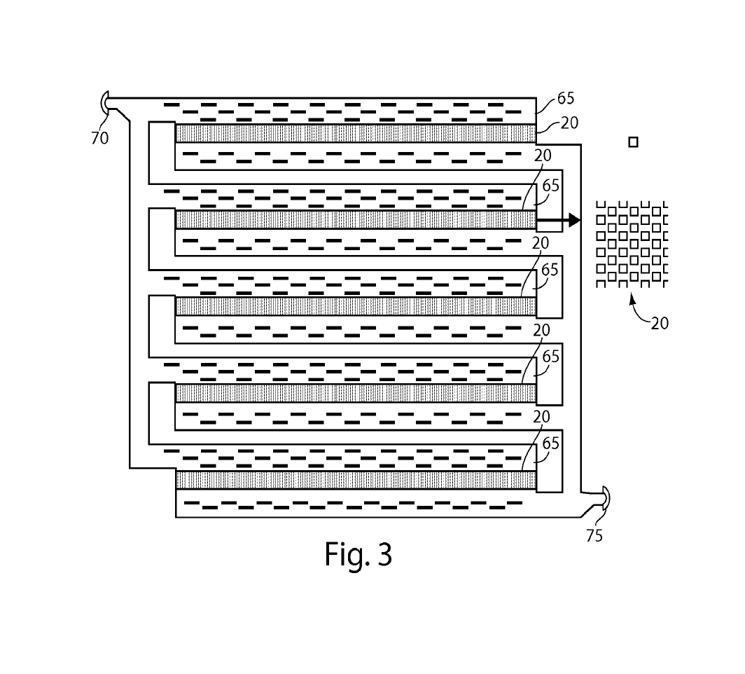

In addition, in some embodiments, more than one channel containing an array of obstructions may be parallelized to further increase the throughput of the device. In some embodiments, the design of the device may allow channels to be easily parallelized, e.g., by counting more than one channel containing arrays to the same inlet and outlet. As illustratively shown in FIG. 3, a parallelized device may comprise a plurality of channels 65 that are connected at the inlet 70 and outlet 75 of the channels. As shown in FIG. 3, each channel may contain an array of obstructions 20 (for clarity, the inset shows a blown up portion of the array of obstructions). For example, each channel may contain 20 rows and 500 columns of obstructions.

In some cases, relatively large numbers of devices may be used in parallel, for example at least about 10 devices, at least about 30 devices, at least about 50 devices, at least about 75 devices, at least about 100 devices, at least about 200 devices, at least about 300 devices, at least about 500 devices, at least about 750 devices, or at least about 1,000 devices or more may be operated in parallel. By using relatively large numbers of devices, greater numbers of droplets may be easily produced, without requiring any scale-up. Thus, for example, the production rate of droplets can be readily controlled or changed by simply selecting an appropriate number of devices. In some embodiments, multiple devices can be connecting together with common inlets and/or outlets (e.g., from a common fluid source and/or to a common collector), although in other embodiments, separate inlets and/or outlets may be used. The devices may comprise different channels, orifices, microfluidics, etc. in some embodiments. In some cases, an array of such devices may be formed by stacking the devices horizontally and/or vertically. The devices may be commonly controlled, or separately controlled, and can be provided with common or separate sources of fluids, depending on the application. In some embodiments, a channel containing an array of obstructions may be combined with any other droplet dividing device known to those of ordinary skill in the art.

In some embodiments, a droplet may undergo additional processes, e.g., before or after exiting the array. In one example, a droplet entering or exiting the array may be converted into a particle (e.g., by a polymerization process). In another example, a droplet may undergo sorting and/or detection after exiting the array. For example, a species within a droplet may be determined, and the droplet may be sorted based on that determination. In general, a droplet may undergo any suitable process known to those of ordinary skill in the art after passing through array of obstructions. See, e.g., Int. Pat. Apl. No. PCT/US2004/010903, filed Apr. 9, 2004, entitled “Formation and Control of Fluidic Species,” by Link, et al., published as WO 2004/091763 on Oct. 28, 2004; Int. Pat. Apl. No. PCT/US2003/020542, filed Jun. 30, 2003, entitled “Method and Apparatus for Fluid Dispersion,” by Stone, et al., published as WO 2004/002627 on Jan. 8, 2004; Int. Pat. Apl. No. PCT/US2006/007772, filed Mar. 3, 2006, entitled “Method and Apparatus for Forming Multiple Emulsions,” by Weitz, et al., published as WO 2006/096571 on Sep. 14, 2006; Int. Pat. Apl. No. PCT/US2004/027912, filed Aug. 27, 2004, entitled “Electronic Control of Fluidic Species,” by Link, et al., published as WO 2005/021151 on Mar. 10, 2005, each of which is incorporated herein by reference in their entireties.

As described herein, an array of obstructions may have certain characteristics (e.g., number of rows, row angle, offsets, average horizontal spacing of the obstructions, average vertical spacing of the obstructions, average interstitial area, average interstitial volume, number of columns, etc.) that can be used to affect droplet division or the characteristic dimensions of the droplets that exit the array. For example, in some embodiments, the number of rows in the array may be selected to achieve a particular average droplet characteristic dimension. In certain cases, the number of rows in the array may be optimized to achieve a certain droplet characteristic dimension without adversely affecting other components in the device. For instances, the number or rows need to achieve a particular average droplet characteristic dimension without adversely affecting the device may be from about 20 to about 30 rows.

Thus, in general, the number of rows in the array may be selected as desired. For instance, in some embodiments, the number of rows in the array may be greater than or equal to about 10, greater than or equal to about 20, greater than or equal to about 30, greater than or equal to about 40, greater than or equal to about 50, greater than or equal to about 70, or greater than or equal to about 90. In some instances, the number of rows in the array may be less than about 100, less than about 80, less than about 60, less than about 40, less than about 20, or less than about 10. Combinations of the above-referenced ranges are also possible (e.g., greater than or equal to about 5 and less than about 100). Other possible values for the number of rows in the array of obstructions are also possible. In some cases, scale-up of the devices may be readily accomplished by adding more columns of obstructions. For example, adding more columns (and making the device wider) can allow for greater throughput of fluid through the channel without changing the fundamental geometry of the obstructions that are used to cause the droplets to break into two or more droplets.

In some embodiments, the orientation of the rows in the array may be selected to facilitate droplet division. In certain embodiments, at least one row (e.g., at least about 40% of the rows, at least about 60% of the rows, at least about 80% of the rows, at least about 90% of the rows, at least about 95% of the rows, at least about 98% of the rows) may be at a non-zero angle with respect to the average direction of fluid flow. In some embodiments, the non-zero angle is 90 degrees. In some instances, one row may have substantially the same non-zero angle with respect to the average direction of fluid flow as another row. For instance, substantially all the rows may be at substantially the non-zero angle with respect to the average direction of fluid flow. In certain cases, one row may have a different non-zero angle with respect to the average direction of fluid flow than another row.

Accordingly, in general, the angle of a row with respect to the average direction of fluid flow may be selected as desired. For instance, in some embodiments, the angle of a row within a channel, with respect to the average direction of fluid flow may be greater than or equal to about 5 degrees, greater than or equal to about 30 degrees, greater than or equal to about 45 degrees, greater than or equal to about 60 degrees, greater than or equal to about 90 degrees, greater than or equal to about 115 degrees, greater than or equal to about 135 degrees, or greater than or equal to about 150 degrees. In some instances, the angle of a row with respect to the average direction of fluid flow may be less than about 180 degrees, less than about 150 degrees, less than about 120 degrees, less than about 90 degrees, less than about 60 degrees, or less than about 30 degrees. Combinations of the above-referenced ranges are also possible (e.g., greater than or equal to about 60 degrees and less than about 150 degrees). Other possible values of the angle of a row with respect to the average direction of fluid flow are also possible.

In certain embodiments, the offset of the centers of obstructions in a row relative to the centers of obstructions in another row in the array may be selected to facilitate droplet division. For example, in one set of embodiments, the obstructions may be offset such that the midpoint of the spacing between the centers of two obstructions in a first row is aligned with the center of an obstruction of an adjacent second row, as was discussed with reference to FIG. 2A. In some instances, the offset of the centers of the obstructions in a row relative to the centers of the obstructions in an adjacent row in the array may be selected to achieve a particular droplet characteristic dimension. In some embodiments, the centers of obstructions in at least some rows (e.g., at least about 40% of the rows, at least about 60% of the rows, at least about 80% of the rows, at least about 90% of the rows, at least about 95% of the rows, at least about 98% of the rows) may be offset relative to the centers of obstructions in an another row (e.g., adjacent).

In some instances, the offset between the centers of obstructions in a two rows may be substantially the same as the centers of obstructions in another two rows. For instance, substantially all the centers of obstructions in a row may have substantially the same offset relative to the centers of obstructions in another row (e.g., next nearest neighbor). In certain cases, the offset between the centers of obstructions in two rows may be different than the offset between the centers of obstructions in another two rows. In some embodiments, the offset of a row relative to another row may be determined by calculating the average difference between the centers of obstructions in a first row and the centers of obstructions in a second row. Other possible values of the offset of one row relative to another row are also possible.

In certain embodiments, the average spacing between an obstruction and a next nearest obstruction in a row may be selected to facilitate droplet division and/or achieve a particular droplet characteristic dimension. For instance, in some embodiments, the average horizontal spacing between an obstruction and a next nearest obstruction in a row may be greater than or equal to about be greater than or equal to about 1 micrometer, greater than or equal to about 5 micrometers, greater than or equal to about 5 micrometers, greater than or equal to about 10 micrometers, greater than or equal to about 20 micrometers, greater than or equal to about 30 micrometers, greater than or equal to about 40 micrometers, greater than or equal to about 50 micrometers, greater than or equal to about 75 micrometers, greater than or equal to about 100 micrometers greater than or equal to about 200 micrometers, greater than or equal to about 500 micrometers, greater than or equal to about 750 micrometers. In some instances, the average horizontal spacing between obstruction and a next nearest obstruction in a row may be less than about 1,000 micrometers, less than about 750 micrometers, less than about 500 micrometers, less than about 250 micrometers, less than about 100 micrometers, less than about 80 micrometers, less than about 60 micrometers, less than about 40 micrometers, less than about 20 micrometers, less than about 10 micrometers, or less than about 5 micrometers. Combinations of the above-referenced ranges are also possible (e.g., greater than or equal to about 1 micrometers and less than about 100 micrometers). Other possible values of the average horizontal spacing are also possible.

In certain embodiments, the array of obstructions may contain columns as shown in FIG. 2A. In some instances, the number of columns of obstructions may be selected to influence the device throughput and the speed of the emulsion in the device. In general the number of columns may be selected as desired. For instance, in some embodiments, the number of columns in the array may be greater than or equal to about 5, greater than or equal to about 10, greater than or equal to about 25, greater than or equal to about 50, greater than or equal to about 75, greater than or equal to about 100, greater than or equal to about 150, greater than or equal to about 200, greater than or equal to about 300, greater than or equal to about 500, or greater than equal to about 750. In some instances, the number of columns in the array may be less than about 1,000, less than about 800, less than about 600, less than about 400, less than about 200, less than about 100, less than about 75, less than about 50, less than about 30, or less than about 15. Combinations of the above-referenced ranges are also possible (e.g., greater than or equal to about 100 and less than about 1,000). Other possible values of the number of columns in the array are also possible.

In some embodiments, the average spacing between an obstruction and a next nearest neighboring obstruction in a column may be greater than or equal to about 1 micrometer, greater than or equal to about 5 micrometers, greater than or equal to about 5 micrometers, greater than or equal to about 10 micrometers, greater than or equal to about 20 micrometers, greater than or equal to about 30 micrometers, greater than or equal to about 40 micrometers, greater than or equal to about 50 micrometers, greater than or equal to about 75 micrometers, greater than or equal to about 100 micrometers greater than or equal to about 200 micrometers, greater than or equal to about 500 micrometers, greater than or equal to about 750 micrometers. In some instances, the average vertical spacing between obstruction and a next nearest obstruction in a column may be less than about 1,000 micrometers, less than about 750 micrometers, less than about 500 micrometers, less than about 250 micrometers, less than about 100 micrometers, less than about 80 micrometers, less than about 60 micrometers, less than about 40 micrometers, less than about 20 micrometers, less than about 10 micrometers, or less than about 5 micrometers. Combinations of the above-referenced ranges are also possible (e.g., greater than or equal to about 1 micrometers and less than about 100 micrometers). Other possible values of the average vertical spacing are also possible

From the average horizontal spacing and the average vertical spacing, the interstitial volume can be calculated as the average interstitial area of the array multiplied by the height of the fluidic channel. In certain embodiments, the average interstitial area of the array may be less than about 10,000 square micrometers, less than about 8,000 square micrometers, less than about 6,000 square micrometers, less than about 4,000 square micrometers, less than about 2,000 square micrometers, less than about 1,000 square micrometers, less than about 800 square micrometers, or less than about 400 square micrometers. In some instances, the average interstitial area of the array may be greater than or equal to about 200 square micrometers, greater than or equal to about 400 square micrometers, greater than or equal to about 800 square micrometers, greater than or equal to about 1,200 square micrometers, greater than or equal to about 1,600 square micrometers, greater than or equal to about 2,000 square micrometers, greater than or equal to about 4,000 square micrometers, greater than or equal to about 6,000 square micrometers, or greater than or equal to about 8,000 square micrometers. Combinations of the above-referenced ranges are also possible (e.g., greater than or equal to about 200 square micrometers and less than about 2,000 square micrometers). Other values of average interstitial area are also possible.

In some embodiments, the average interstitial volume of the array may be may be less than about 200,000 cubic micrometers, less than about 175,000 cubic micrometers, less than about 150,000 cubic micrometers, less than about 125,000 cubic micrometers, less than about 100,000 cubic micrometers, less than about 75,000 cubic micrometers, less than about 50,000 cubic micrometers, or less than about 25,000 cubic micrometers. In some instances, the average interstitial volume of the array may be greater than or equal to about 10,000 cubic micrometers, greater than or equal to about 25,000 cubic micrometers, greater than or equal to about 50,000 cubic micrometers, greater than or equal to about 75,000 cubic micrometers, greater than or equal to about 100,000 cubic micrometers, greater than or equal to about 125,000 cubic micrometers, greater than or equal to about 150,000 cubic micrometers, or greater than or equal to about 175,000 cubic micrometers. Combinations of the above-referenced ranges are also possible (e.g., greater than or equal to about 10,000 cubic micrometers and less than about 150,000 cubic micrometers). Other values of average interstitial volume are also possible.

It should also be understood that the overall height of the channel need not be constant and may vary throughout the channel, in certain embodiments. For instance, the channel may be tallest at the inlet and thinnest at the outlet, or vice versa.

In some embodiments, the aspect ratio of the dimensions (e.g., length:width) of the obstructions may influence droplet division. In some instances, aspect ratio may influence the average number of divisions a droplet undergoes. In some cases, an obstruction may have substantially the same aspect ratio as another obstruction. In certain cases, substantially all the obstructions may have the same aspect ratio. In general, any suitable aspect ratio may be used. For instances, in some embodiments, the aspect ratio of dimensions of an obstruction may be greater than or equal to about 2, greater than equal to about 3, greater than or equal to about 4, greater than or equal to about 5, greater than or equal to about 10, greater than or equal to about 15, or greater than equal to about 20. In some instances, the aspect ratio of dimensions of an obstruction may be less than about 25, less than about 20, less than about 15, less than about 10, less than about 5, or less than about 3. Combinations of the above-referenced ranges are also possible (e.g., greater than or equal to 2 and less than 15). Other possible values of the aspect ratio are also possible.

In some embodiments, an obstruction may have one or more dimensions (e.g., length, width, height, diameter, etc.) that is greater than or equal to about 1 micrometer, greater than or equal to about 5 micrometers, greater than or equal to about 10 micrometers, greater than or equal to about 15 micrometers, greater than or equal to about 20 micrometers, greater than or equal to 25 micrometers, greater than or equal to 30 micrometers, greater than or equal to 35 micrometers, greater than or equal to 40 micrometers, or greater than or equal to 45 micrometers. In some instances an obstruction may have one or more characteristic dimension of less than about 50 micrometers, less than about 45 micrometers, less than about 40 micrometers, less than about 35 micrometers, less than about 30 micrometers, less than about 25 micrometers, less than about 20 micrometers, less than about 15 micrometers, less than about 10 micrometers, or less and about 5 micrometers. Combinations of the above-referenced ranges are also possible (e.g., greater than or equal to about 1 micrometer and less than about 40 micrometers).

As discussed, passing a plurality of droplets through the array of obstructions may divide at least a portion of the droplets to form a plurality of divided droplets. For instance, in some embodiments, the percentage of droplets entering the array that undergo at least one division before exiting the array may be at least about 30% (e.g., at least about 40%, at least about 50%, at least about 60%, at least about 70%, at least about 80%, at least about 90%, at least about 95%, least about 98%, 100%). In some cases the substantially all of the droplets are divided to form a plurality of divided droplets.

In some embodiments, the shear stress applied to a droplet during the division process may be greater than or equal to about 0.001 Pa, greater than or equal to about 0.01 Pa, greater than or equal to about 0.1 Pa greater than or equal to about 0.5 Pa, greater equal to about 1 Pa, greater equal to about 2 Pa, greater equal to about 3 Pa, or greater than or equal to about 4 Pa. In some instances the shear stress applied to a droplet may be less than about 5 Pa, less than about 4 Pa, less than about 3 Pa, less than about 2 Pa, less than about 1 Pa, or less than about 0.5 Pa. Combinations of the above-reference ranges are also possible (e.g., greater than or equal to about 0.5 Pa and less than about 3 Pa). Other possible values for shear stress are also possible. The shear stress applied to a droplet during the division process may be determined through estimation using known values of the viscosity of the dispersed phase, viscosity of the continuous phase, and the average velocity of the fluid in the channel.

The droplets exiting the array may be relatively monodisperse in some embodiments. In some cases, the droplets exiting the array may have a distribution of characteristic dimensions such that no more than about 10%, about 5%, about 4%, about 3%, about 2%, about 1%, or less, of the droplets have a characteristic dimension greater than or less than about 20%, about 30%, about 50%, about 75%, about 80%, about 90%, about 95%, about 99%, or more, of the average characteristic dimension of all of the droplets. Those of ordinary skill in the art will be able to determine the average characteristic dimension of a population of droplets, for example, using laser light scattering, microscopic examination, or other known techniques.

The average characteristic dimension of droplets exiting the array (e.g., after being divided) may be, for example, less than about 1 mm, less than about 500 micrometers, less than about 200 micrometers, less than about 100 micrometers, less than about 75 micrometers, less than about 50 micrometers, less than about 25 micrometers, less than about 10 micrometers, or less than about 5 micrometers in some cases. The average characteristic dimension may also be greater than or equal to about 1 micrometer, greater than or equal to about 2 micrometers, greater than or equal to about 3 micrometers, greater than or equal to about 5 micrometers, greater than or equal to about 10 micrometers, greater than or equal to about 15 micrometers, or greater than or equal to about 20 micrometers in certain cases.

In certain embodiments, the viscosity ratio of the dispersed phase to the continuous phase may be selected as desired. In some embodiments, the viscosity ratio of the dispersed phase to the continuous phase may be less than about 40, less than about 20, less than about 10, less than 5, or less than about 1. In some instances the viscosity ratio of the diverse phase to continuous phase may be greater than or equal to about 1, greater than or equal to about 6, greater than or equal to about 10, greater than or equal to about 20, or greater than or equal to about 30. Combinations of the above-referenced ranges are also possible (e.g., greater than or equal to about 1 and less than 10). Other values are also possible. The viscosity of the dispersed phase and the continuous phase may be determined using a viscometer.

Certain aspects of the invention are generally directed to channels such as those described above. In some cases, the channels may be microfluidic channels, but in certain instances, not all of the channels are microfluidic. There can be any number of channels, including microfluidic channels, within the device, and the channels may be arranged in any suitable configuration. The channels may independently be straight, curved, bent, etc. In some cases, a relatively large length of channels may be present in the device. For example, in some embodiments, the channels within a device, when added together, can have a total length of at least about 100 micrometers, at least about 300 micrometers, at least about 500 micrometers, at least about 1 mm, at least about 3 mm, at least about 5 mm, at least about 10 mm, at least about 30 mm, at least 50 mm, at least about 100 mm, at least about 300 mm, at least about 500 mm, at least about 1 m, at least about 2 m, or at least about 3 m in some cases.

“Microfluidic,” as used herein, refers to an article or device including at least one fluid channel having a cross-sectional dimension of less than about 1 mm. The “cross-sectional dimension” of the channel is measured perpendicular to the direction of net fluid flow within the channel. Thus, for example, some or all of the fluid channels in a device can have a maximum cross-sectional dimension less than about 2 mm, and in certain cases, less than about 1 mm. In one set of embodiments, all fluid channels in a device are microfluidic and/or have a largest cross sectional dimension of no more than about 2 mm or about 1 mm. In certain embodiments, the fluid channels may be formed in part by a single component (e.g. an etched substrate or molded unit). Of course, larger channels, tubes, chambers, reservoirs, etc. can be used to store fluids and/or deliver fluids to various elements or devices in other embodiments of the invention, for example. In one set of embodiments, the maximum cross-sectional dimension of the channels in a device is less than 500 micrometers, less than 200 micrometers, less than 100 micrometers, less than 50 micrometers, or less than 25 micrometers.

A “channel,” as used herein, means a feature on or in a device or substrate that at least partially directs flow of a fluid. The channel can have any cross-sectional shape (circular, oval, triangular, irregular, square, or rectangular, or the like) and can be covered or uncovered. In embodiments where it is completely covered, at least one portion of the channel can have a cross-section that is completely enclosed, or the entire channel may be completely enclosed along its entire length with the exception of its inlets and/or outlets or openings. A channel may also have an aspect ratio (length to average cross sectional dimension) of at least 2:1, more typically at least 3:1, 4:1, 5:1, 6:1, 8:1, 10:1, 15:1, 20:1, or more. An open channel generally will include characteristics that facilitate control over fluid transport, e.g., structural characteristics (an elongated indentation) and/or physical or chemical characteristics (hydrophobicity vs. hydrophilicity) or other characteristics that can exert a force (e.g., a containing force) on a fluid. The fluid within the channel may partially or completely fill the channel. In some cases where an open channel is used, the fluid may be held within the channel, for example, using surface tension (i.e., a concave or convex meniscus).

The channel may be of any size, for example, having a largest dimension perpendicular to net fluid flow of less than about 5 mm or 2 mm, or less than about 1 mm, less than about 500 micrometers, less than about 200 micrometers, less than about 100 micrometers, less than about 60 micrometers, less than about 50 micrometers, less than about 40 micrometers, less than about 30 micrometers, less than about 25 micrometers, less than about 10 micrometers, less than about 3 micrometers, less than about 1 micrometer, less than about 300 nm, less than about 100 nm, less than about 30 nm, or less than about 10 nm. In some cases, the dimension of the channel are chosen such that fluid is able to freely flow through the device or substrate. The dimension of the channel may also be chosen, for example, to allow a certain volumetric or linear flow rate of fluid in the channel. Of course, the number of channels and the shape of the channels can be varied by any method known to those of ordinary skill in the art. In some cases, more than one channel may be used. For example, two or more channels may be used, where they are positioned adjacent or proximate to each other, positioned to intersect with each other, etc.

In certain embodiments, one or more of the channels within the device may have an average cross-sectional dimension of less than about 10 cm. In certain instances, the average cross-sectional dimension of the channel is less than about 5 cm, less than about 3 cm, less than about 1 cm, less than about 5 mm, less than about 3 mm, less than about 1 mm, less than 500 micrometers, less than 200 micrometers, less than 100 micrometers, less than 50 micrometers, or less than 25 micrometers. The “average cross-sectional dimension” is measured in a plane perpendicular to net fluid flow within the channel. If the channel is non-circular, the average cross-sectional dimension may be taken as the diameter of a circle having the same area as the cross-sectional area of the channel. Thus, the channel may have any suitable cross-sectional shape, for example, circular, oval, triangular, irregular, square, rectangular, quadrilateral, or the like. In some embodiments, the channels are sized so as to allow laminar flow of one or more fluids contained within the channel to occur.

The channel may also have any suitable cross-sectional aspect ratio. The “cross-sectional aspect ratio” is, for the cross-sectional shape of a channel, the largest possible ratio (large to small) of two measurements made orthogonal to each other on the cross-sectional shape. For example, the channel may have a cross-sectional aspect ratio of less than about 2:1, less than about 1.5:1, or in some cases about 1:1 (e.g., for a circular or a square cross-sectional shape). In other embodiments, the cross-sectional aspect ratio may be relatively large. For example, the cross-sectional aspect ratio may be at least about 2:1, at least about 3:1, at least about 4:1, at least about 5:1, at least about 6:1, at least about 7:1, at least about 8:1, at least about 10:1, at least about 12:1, at least about 15:1, or at least about 20:1.

As mentioned, the channels can be arranged in any suitable configuration within the device. Different channel arrangements may be used, for example, to manipulate fluids, droplets, and/or other species within the channels. For example, channels within the device can be arranged to create droplets (e.g., discrete droplets, single emulsions, double emulsions or other multiple emulsions, etc.), to mix fluids and/or droplets or other species contained therein, to screen or sort fluids and/or droplets or other species contained therein, to split or divide fluids and/or droplets, to cause a reaction to occur (e.g., between two fluids, between a species carried by a first fluid and a second fluid, or between two species carried by two fluids to occur), or the like.

Fluids may be delivered into channels within a device via one or more fluid sources. Any suitable source of fluid can be used, and in some cases, more than one source of fluid is used. For example, a pump, gravity, capillary action, surface tension, electroosmosis, centrifugal forces, etc. may be used to deliver a fluid from a fluid source into one or more channels in the device. Non-limiting examples of pumps include syringe pumps, peristaltic pumps, pressurized fluid sources, or the like. The device can have any number of fluid sources associated with it, for example, 1, 2, 3, 4, 5, 6, 7, 8, 9, 10, etc., or more fluid sources. The fluid sources need not be used to deliver fluid into the same channel, e.g., a first fluid source can deliver a first fluid to a first channel while a second fluid source can deliver a second fluid to a second channel, etc. In some cases, two or more channels are arranged to intersect at one or more intersections. There may be any number of fluidic channel intersections within the device, for example, 2, 3, 4, 5, 6, etc., or more intersections.

A variety of materials and methods, according to certain aspects of the invention, can be used to form devices or components such as those described herein, e.g., channels such as microfluidic channels, chambers, etc. For example, various devices or components can be formed from solid materials, in which the channels can be formed via micromachining, film deposition processes such as spin coating and chemical vapor deposition, laser fabrication, photolithographic techniques, etching methods including wet chemical or plasma processes, and the like. See, for example, Scientific American, 248:44-55, 1983 (Angell, et al).

In one set of embodiments, various structures or components of the devices described herein can be formed of a polymer, for example, an elastomeric polymer such as polydimethylsiloxane (“PDMS”), polytetrafluoroethylene (“PTFE” or Teflon®), or the like. For instance, according to one embodiment, a microfluidic channel may be implemented by fabricating the fluidic device separately using PDMS or other soft lithography techniques (details of soft lithography techniques suitable for this embodiment are discussed in the references entitled “Soft Lithography,” by Younan Xia and George M. Whitesides, published in the Annual Review of Material Science, 1998, Vol. 28, pages 153-184, and “Soft Lithography in Biology and Biochemistry,” by George M. Whitesides, Emanuele Ostuni, Shuichi Takayama, Xingyu Jiang and Donald E. Ingber, published in the Annual Review of Biomedical Engineering, 2001, Vol. 3, pages 335-373; each of these references is incorporated herein by reference).

Other examples of potentially suitable polymers include, but are not limited to, polyethylene terephthalate (PET), polyacrylate, polymethacrylate, polycarbonate, polystyrene, polyethylene, polypropylene, polyvinylchloride, cyclic olefin copolymer (COC), polytetrafluoroethylene, a fluorinated polymer, a silicone such as polydimethylsiloxane, polyvinylidene chloride, bis-benzocyclobutene (“BCB”), a polyimide, a fluorinated derivative of a polyimide, or the like. Combinations, copolymers, or blends involving polymers including those described above are also envisioned. The device may also be formed from composite materials, for example, a composite of a polymer and a semiconductor material.

In some embodiments, various structures or components of the device are fabricated from polymeric and/or flexible and/or elastomeric materials, and can be conveniently formed of a hardenable fluid, facilitating fabrication via molding (e.g. replica molding, injection molding, cast molding, etc.). The hardenable fluid can be essentially any fluid that can be induced to solidify, or that spontaneously solidifies, into a solid capable of containing and/or transporting fluids contemplated for use in and with the fluidic network. In one embodiment, the hardenable fluid comprises a polymeric liquid or a liquid polymeric precursor (i.e. a “prepolymer”). Suitable polymeric liquids can include, for example, thermoplastic polymers, thermoset polymers, waxes, metals, or mixtures or composites thereof heated above their melting point. As another example, a suitable polymeric liquid may include a solution of one or more polymers in a suitable solvent, which solution forms a solid polymeric material upon removal of the solvent, for example, by evaporation. Such polymeric materials, which can be solidified from, for example, a melt state or by solvent evaporation, are well known to those of ordinary skill in the art. A variety of polymeric materials, many of which are elastomeric, are suitable, and are also suitable for forming molds or mold masters, for embodiments where one or both of the mold masters is composed of an elastomeric material. A non-limiting list of examples of such polymers includes polymers of the general classes of silicone polymers, epoxy polymers, methacrylate polymer, and other acrylate polymers. Epoxy polymers are characterized by the presence of a three-membered cyclic ether group commonly referred to as an epoxy group, 1,2-epoxide, or oxirane. For example, diglycidyl ethers of bisphenol A can be used, in addition to compounds based on aromatic amine, triazine, and cycloaliphatic backbones. Another example includes the well-known Novolac polymers. Non-limiting examples of silicone elastomers suitable for use according to the invention include those formed from precursors including the chlorosilanes such as methylchlorosilanes, ethylchlorosilanes, phenylchlorosilanes, etc.

Silicone polymers are used in certain embodiments, for example, the silicone elastomer polydimethylsiloxane. Non-limiting examples of PDMS polymers include those sold under the trademark Sylgard by Dow Chemical Co., Midland, Mich., and particularly Sylgard 182, Sylgard 184, and Sylgard 186. Silicone polymers including PDMS have several beneficial properties simplifying fabrication of various structures of the invention. For instance, such materials are inexpensive, readily available, and can be solidified from a prepolymeric liquid via curing with heat. For example, PDMSs are typically curable by exposure of the prepolymeric liquid to temperatures of about, for example, about 65° C. to about 75° C. for exposure times of, for example, about an hour. Also, silicone polymers, such as PDMS, can be elastomeric and thus may be useful for forming very small features with relatively high aspect ratios, necessary in certain embodiments of the invention. Flexible (e.g., elastomeric) molds or masters can be advantageous in this regard.

One advantage of forming structures such as microfluidic structures or channels from silicone polymers, such as PDMS, is the ability of such polymers to be oxidized, for example by exposure to an oxygen-containing plasma such as an air plasma, so that the oxidized structures contain, at their surface, chemical groups capable of cross-linking to other oxidized silicone polymer surfaces or to the oxidized surfaces of a variety of other polymeric and non-polymeric materials. Thus, structures can be fabricated and then oxidized and essentially irreversibly sealed to other silicone polymer surfaces, or to the surfaces of other substrates reactive with the oxidized silicone polymer surfaces, without the need for separate adhesives or other sealing means. In most cases, sealing can be completed simply by contacting an oxidized silicone surface to another surface without the need to apply auxiliary pressure to form the seal. That is, the pre-oxidized silicone surface acts as a contact adhesive against suitable mating surfaces. Specifically, in addition to being irreversibly sealable to itself, oxidized silicone such as oxidized PDMS can also be sealed irreversibly to a range of oxidized materials other than itself including, for example, glass, silicon, silicon oxide, quartz, silicon nitride, polyethylene, polystyrene, glassy carbon, and epoxy polymers, which have been oxidized in a similar fashion to the PDMS surface (for example, via exposure to an oxygen-containing plasma). Oxidation and sealing methods useful in the context of the present invention, as well as overall molding techniques, are described in the art, for example, in an article entitled “Rapid Prototyping of Microfluidic Devices and Polydimethylsiloxane,” Anal. Chem., 70:474-480, 1998 (Duffy et al.), incorporated herein by reference.

In some aspects, one or more walls or portions of a channel may be coated, e.g., with a coating material, including photoactive coating materials. For example, in some embodiments, each of the microfluidic channels at the common junction may have substantially the same hydrophobicity, although in other embodiments, various channels may have different hydrophobicities. For example a first channel (or set of channels) at a common junction may exhibit a first hydrophobicity, while the other channels may exhibit a second hydrophobicity different from the first hydrophobicity, e.g., exhibiting a hydrophobicity that is greater or less than the first hydrophobicity. Non-limiting examples of devices and methods for coating microfluidic channels, for example, with sol-gel coatings, may be seen in International Patent Application No. PCT/US2009/000850, filed Feb. 11, 2009, entitled “Surfaces, Including Microfluidic Channels, With Controlled Wetting Properties,” by Abate, et al., published as WO 2009/120254 on Oct. 1, 2009, and International Patent Application No. PCT/US2008/009477, filed Aug. 7, 2008, entitled “Metal Oxide Coating on Surfaces,” by Weitz, et al., published as WO 2009/020633 on Feb. 12, 2009, each incorporated herein by reference in its entirety.

A variety of definitions are now provided which will aid in understanding various aspects of the invention. Following, and interspersed with these definitions, is further disclosure that will more fully describe the invention.

A “droplet,” as used herein, is an isolated portion of a first fluid that is completely surrounded by a second fluid. In some cases, the first fluid and the second fluid are substantially immiscible. It is to be noted that a droplet is not necessarily spherical, but may assume other shapes as well, for example, depending on the external environment. The diameter of a droplet, in a non-spherical droplet, is the diameter of a perfect mathematical sphere having the same volume as the non-spherical droplet. The droplets may be created using any suitable technique, as previously discussed.

As used herein, a “fluid” is given its ordinary meaning, i.e., a liquid or a gas. A fluid cannot maintain a defined shape and will flow during an observable time frame to fill the container in which it is put. Thus, the fluid may have any suitable viscosity that permits flow. If two or more fluids are present, each fluid may be independently selected among essentially any fluids (liquids, gases, and the like) by those of ordinary skill in the art.

Certain embodiments of the present invention provide a plurality of droplets. In some embodiments, the plurality of droplets is formed from a first fluid, and may be substantially surrounded by a second fluid. As used herein, a droplet is “surrounded” by a fluid if a closed loop can be drawn around the droplet through only the fluid. A droplet is “completely surrounded” if closed loops going through only the fluid can be drawn around the droplet regardless of direction. A droplet is “substantially surrounded” if the loops going through only the fluid can be drawn around the droplet depending on the direction (e.g., in some cases, a loop around the droplet will comprise mostly of the fluid by may also comprise a second fluid, or a second droplet, etc.).

In most, but not all embodiments, the droplets and the fluid containing the droplets are substantially immiscible. In some cases, however, they may be miscible. In some cases, a hydrophilic liquid may be suspended in a hydrophobic liquid, a hydrophobic liquid may be suspended in a hydrophilic liquid, a gas bubble may be suspended in a liquid, etc. Typically, a hydrophobic liquid and a hydrophilic liquid are substantially immiscible with respect to each other, where the hydrophilic liquid has a greater affinity to water than does the hydrophobic liquid. Examples of hydrophilic liquids include, but are not limited to, water and other aqueous solutions comprising water, such as cell or biological media, ethanol, salt solutions, etc. Examples of hydrophobic liquids include, but are not limited to, oils such as hydrocarbons, silicon oils, fluorocarbon oils, organic solvents etc. In some cases, two fluids can be selected to be substantially immiscible within the time frame of formation of a stream of fluids. Those of ordinary skill in the art can select suitable substantially miscible or substantially immiscible fluids, using contact angle measurements or the like, to carry out the techniques of the invention.

The following examples are intended to illustrate certain embodiments of the present invention, but do not exemplify the full scope of the invention.

### Example 1

Microparticles are omnipresent in everyday life; they are contained in cosmetic creams, food and serve as drug delivery vehicles, among other applications. Microparticles can be assembled using many different technologies such as spray drying, homogenization, bulk emulsification, or membrane filtration. However, the control over the size of particles produced with these techniques is often limited. Since the size of particles influences their effect on the properties of a product, the limited control over the particle size may restrict the performance of particle produced by these techniques in many applications. By contrast, microfluidics may allow the production of substantially monodisperse particles with close control over their size and composition. Typical frequencies with which particles are formed in conventional microfluidic devices range from 1 to 10 kHz. Conventional microfluidic devices may be used to produce particles with small volumes. For products containing particles produced by conventional microfluidic devices, the small volume of the particles often necessitates the addition of a large number of particles to achieve a conceivable effect, even if the concentration of particles in products (e.g., cosmetic creams, food) is low. Thus, if particles produced by microfluidic devices are intended as additives of products (e.g., cosmetic creams, food) that are sold in large volumes, the throughput of microfluidic devices has to be significantly increased.

One possibility is to increase the throughput in microfluidic devices by parallelizing individual droplet makers by connecting the different inlets through distribution channels. However, the amount of particles produced in a typical microfluidic device ranges from 50 micrograms/h to 1 g/h, depending on factors such as the size of particles, the viscosities, and surface tension of the solutions. In addition, the failure of even a single droplet maker in an array of droplet makers can sometimes result in increased polydispersity of the product. In contrast, the following examples demonstrate methods generally directed to microfluidic devices with arrays of obstructions that allow the production of microparticles at relatively high throughput and fidelity.

The following examples describe various microfluidic devices that allow high throughput production of single emulsions with droplet sizes between 3 and 20 micrometers in diameter. The microfluidic devices included an inlet where an emulsion was injected and an outlet where an emulsion having a substantially monodisperse distribution of diameters was collected. See FIG. 1. The device of FIG. 1 had an array of obstructions arranged in rows. The distance between obstructions was well defined. Adjacent rows of obstructions were offset with respect to each other. The devices were formed from PDMS (polydimethylsiloxane) and were fabricated using soft lithography; however, it is possible to make devices from other materials such as Teflon (polytetrafluoroethylene), photoresist, silicon, or the like, using various techniques. The size of the droplets was found in some of these experiments to generally depend on the applied shear force. The droplet size therefore decreased with increasing flow rates and decreasing distance between adjacent obstructions. The throughput of a single device could also be increased, for example, by making the device wider while keeping the same spacing of obstructions. Furthermore, devices were easily parallelized, for example, by stacking devices on top of each other and connecting them through holes that pass through all the inlets and outlets of the stacked devices.

### Example 2

This example describes the influence of capillary number on droplet size in accordance with one embodiment of the invention. In this example, droplet size was found to be relatively dependent on capillary number below a capillary number of 0.04 for devices with eta_{dispersed}/eta_{continuous} (η_{dispersed}/η_{continuos})>1. Above 2, droplet size was found to be relatively more dependent on device design (e.g., interstitial volume).

A schematic of the device and process of droplet division used in this example can be seen in FIG. 1. The microfluidic device was used to produce water-in-oil (W/O) and oil in water (O/W) emulsions. The different devices were emulsified by mixing two immiscible liquids; the dispersed phase accounted for 60-80 vol %. The continuous phase contained a surfactant to prevent coalescence of droplets. A crude emulsion was formed by mechanically agitating a solution containing the two immiscible liquids before the resulting crude emulsion was injected into the microfluidic device. The microfluidic device was a PDMS based microfluidic chip of arrays of regularly spaced obstructions; adjacent rows of obstructions were offset as shown in FIG. 1. To form a plurality of divided droplets, a crude emulsion made through typical bulk emulsification techniques was injected into the device using volume controlled peristaltic pumps. Optionally, the crude emulsion could be formed in the device. This version of the device allowed the dispersed and continuous phase to be separately injected, which prevented creaming and/or sedimentation of the droplets. It also allowed different components to be mixed in the device shortly before the emulsion was formed, which could be used to allow chemical reactions to occur inside the droplets before the droplets entered the array of obstructions. The crude emulsion droplets were delivered through the array of obstructions and broken up into smaller droplets that had a much narrower size distribution than that of the crude emulsion droplets. Optionally, if the droplets included monomers and a photoinitiator, a polymerization reaction could be initiated by illuminating the divided droplets with ultraviolet (UV) light, for example, while the divided droplets were still in the tubing that connected the outlet with the collection vial.

In the device, droplets were divided if they became “trapped” (i.e., fluid flow near the obstruction became restricted, relative to the average direction of fluid flow through the microfluidic channel) by the obstructions. Droplet division was somewhat analogous to the break-up of droplets that are pushed through a single obstacle present in a narrow microfluidic channel. However, surprisingly, obstructions that are properly spaced can be used to break up droplets to form divided droplets that are substantially monodisperse. As discussed herein, the arrangement of obstructions may be important in creating such a substantially monodisperse distribution; other arrangements (e.g., rectangular arrangements, random arrangements, etc., cannot produce such monodisperse distributions).

After injection into the channel of this microfluidic device, the crude emulsion droplets become trapped such that flow near the obstructions became restricted relative to the direction of average fluid flow within the channel. Such droplets would often become divided by the obstructions. For example, in some cases, the capillary number may exceed a certain value for a given viscosity of the dispersed phase to viscosity of the continuous phase ratio, and the crude emulsion droplets could be broken up to form daughter droplets (i.e., divided droplets). The capillary number can be defined as:

Ca=ηq/(hwγ).

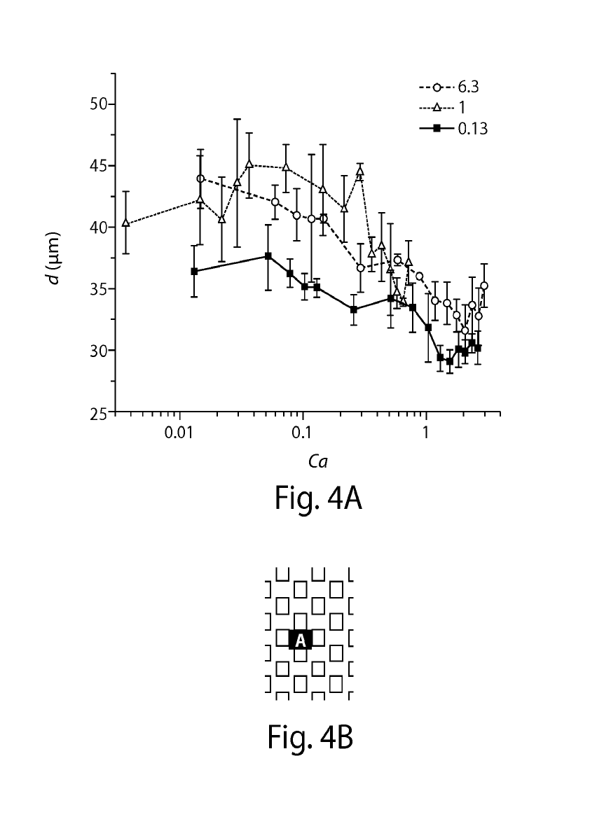

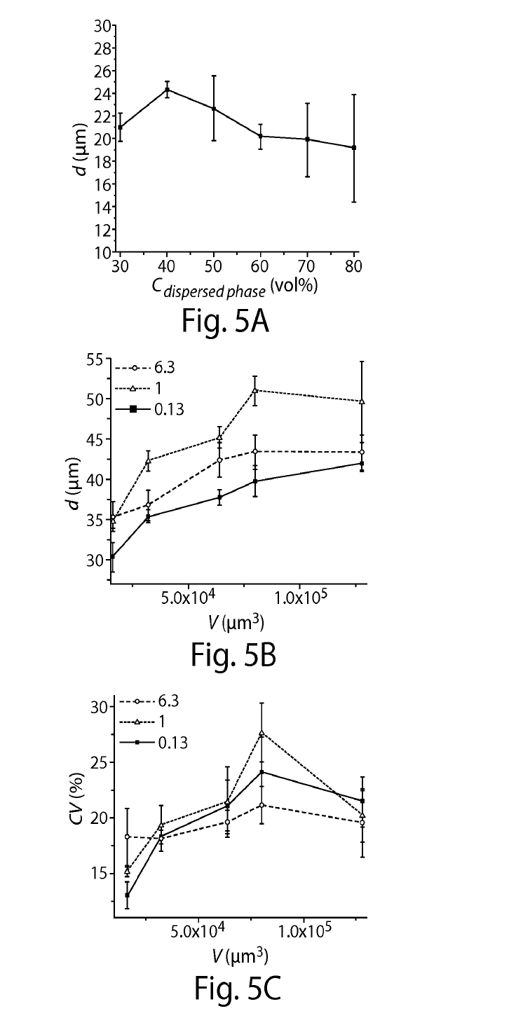

In this equation, eta (η) is the viscosity of the droplets, q the flow rate, h the channel height, w the channel width, and gamma (γ) the surface tension. For W/O emulsions with a viscosity ratio of eta_{dispersed}/eta_{continuous} (η_{dispersed}/η_{continuous})=>1, the size of the droplets in this microfluidic device was found to decrease with increasing capillary number for capillary numbers below 2. However, for larger capillary numbers (i.e., greater than or equal to 2) the size of the droplets reached a plateau value as shown in FIG. 4. Though droplet size in the plateau region (i.e., capillary numbers at or above 2) was independent of the volume fraction of the dispersed phase as shown in FIG. 5A, droplet size in the plateau region did depend on the design of the device. Droplet size in the plateau region decreased with decreasing distance between adjacent obstructions, decreasing height of the obstructions, and therefore decreasing interstitial volume as shown in FIG. 5B.

FIG. 4A shows the size of droplets formed by the microfluidic devices as a function of capillary number. Each microfluidic device in this example contained 80 columns of square obstructions, but each device had different interstitial volumes as indicated in the legend of FIG. 4. Fluid was injected into the devices at 5 ml/h. The emulsion had 60 vol % dispersed and 40 vol % continuous phase. A schematic illustration of the definition of the interstitial volume that was calculated by multiplying the rectangular area between adjacent obstructions (A) with the height of the device is shown in FIG. 4B.

FIG. 5A shows the influence of the concentration of the dispersed phase on droplet size in these devices. The dispersed water phase included 20 wt % PEG with a molecular weight of 6 kDa, and the continuous oil phase included perfluorinated oil containing 1 wt % perfluorinated surfactant. FIG. 5B shows the influence of the design of the devices on the size of the droplets that were delivered through an array of square obstructions. FIG. 5C shows the influence of interstitial volume on the coefficient of variation for certain ratios of the viscosity of the dispersed phase to the viscosity of the continuous phase.

### Example 3

This example describes the influence of geometry of the obstructions on droplet division and size. Diamond obstructions, triangle obstructions, and obstructions with semi-circular indentations exhibited relatively inefficient droplet division, which led to a high coefficient of variation for droplet size. Inefficient droplet division was found to be due to poor trapping of droplets by the obstructions, which reduced the instances of droplets being simultaneously squeezed against and pushed to both sides of the obstructions by incoming fluid. However, some droplet division still occurred. Square and circular obstructions exhibited more efficient droplet division, relative to these shapes, which led to lower coefficients of variation for droplet size.

Microscope images of water-in-oil emulsion droplets in the outlet of microfluidic devices with different obstruction geometries are shown in FIG. 6. The shape of the obstructions is schematically shown in the insets. All devices used in these experiments were 40 micrometers tall and the water-in-oil emulsion flowed through the device at 5 ml/h.

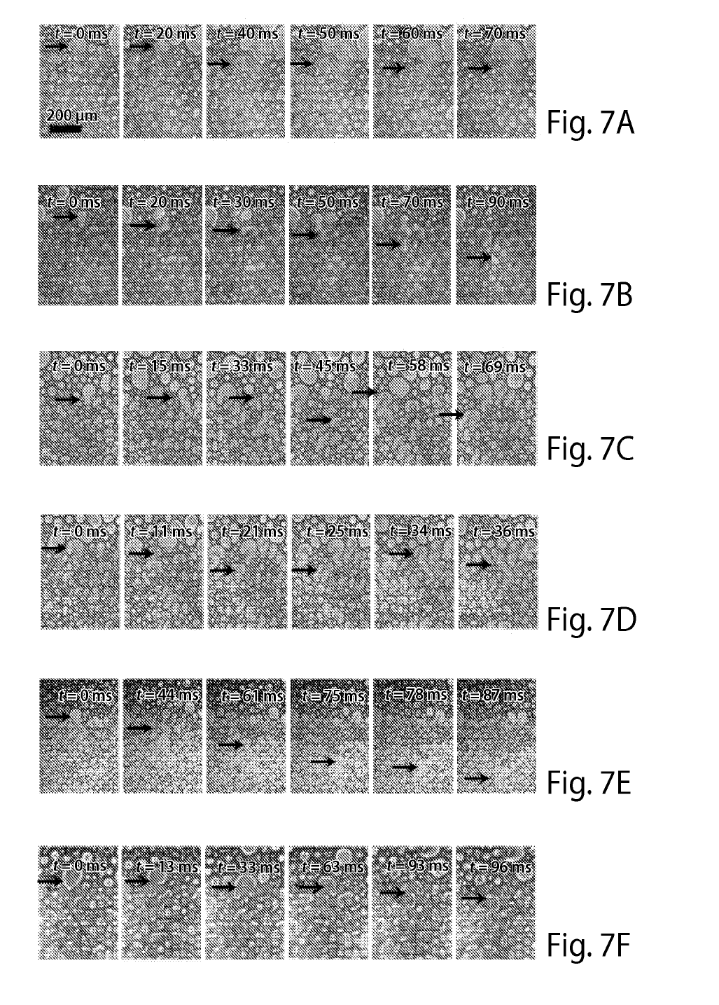

Devices with diamond-shaped obstructions or obstructions with a semi-circular indentation in the average direction of fluid flow had a coefficient of variation (CV) of approximately 50%. The high polydispersity was found to be due to relatively inefficient droplet division, compared to other shapes. For devices with diamond obstructions, the regular arrangement of diamond-shaped obstructions resulted in the formation of diagonal channels that were free of obstructions. Droplets (e.g., the crude emulsion droplets) could flow inside these diagonal channels without becoming trapped by an obstruction; this resulted in inefficient break-up of droplets as shown in FIG. 7. Devices with obstructions with semi-circular indentations in the direction of average fluid flow also exhibited relatively inefficient droplet division. In these devices, fluid flow often slowed before changing direction to by-pass the obstructions. The slowdown occurred as the fluid flowed into the indentations of the obstructions. A droplet that flowed into an indentation was trapped inside the indentation until the continuous phase dragged the droplet to one side of the obstruction. The droplet could then pass by the obstruction without major alteration in the shape of the droplet as shown in FIG. 7. Thus the indentations allowed droplets to avoid being simultaneously squeezed against and pushed to both sides of the obstructions by fluid flow (e.g., of the continuous phase, of other droplets). This resulted in inefficient droplet division and therefore a high polydispersity of droplets as shown in FIG. 6.

Devices with triangular obstructions also exhibited inefficient droplet division in these experiments. Droplets in these devices were not pushed against a wall that was aligned at a 90° angle to the main flow direction of the fluid, which allowed the droplets to pass the obstructions without major alteration in the shape of the droplets, as shown in FIG. 7. The resulting droplets were more polydisperse as shown in FIG. 6.

By contrast, droplets produced in devices with square or circular obstructions had a CV of approximately 20% as shown in FIG. 6. Droplets squeezed through closely packed circular or squared obstructions were efficiently trapped by these obstructions; this led to a high rate of droplet division as shown in FIG. 7. Droplets typically broke at one of the trailing edges of the square obstructions. Depending on the ratio of the droplet size to the interstitial volume, a single droplet could be divided into two or more smaller droplets by the same obstruction. This efficient division of droplets translated into relatively low polydispersity as shown in FIG. 6.

FIG. 7 shows the division of droplets in microfluidic channels with different geometries of obstructions. Time lapsed microscope images of a water-in-oil emulsion that had flowed through arrays containing: a) diamond obstructions, b) obstructions with a semi-circular indentation in the direction of average fluid flow in the microfluidic channel, c) triangular obstructions with a 40 micrometer base, d) triangular obstructions with a 60 micrometer base, e) circular obstructions, and f) square obstructions. The water phase included 20% PEG and the oil phase was a perfluorinated oil containing 1 wt % perfluorinated surfactant.

### Example 4

This example describes a method of increasing the efficiency of droplet division by using rectangular obstructions with varies aspect ratios and varying the volume of the dispersed phase. In the devices used in this example, most droplets could be divided using an array of rectangular obstructions with an aspect ratio of at least 2. The aspect ratio was also found to have an influence on the polydispersity of the droplets and the number of divided droplets formed by a single droplet at a single obstruction. The volume of dispersed phase was also found to influence the polydispersity of the droplets in these experiments.

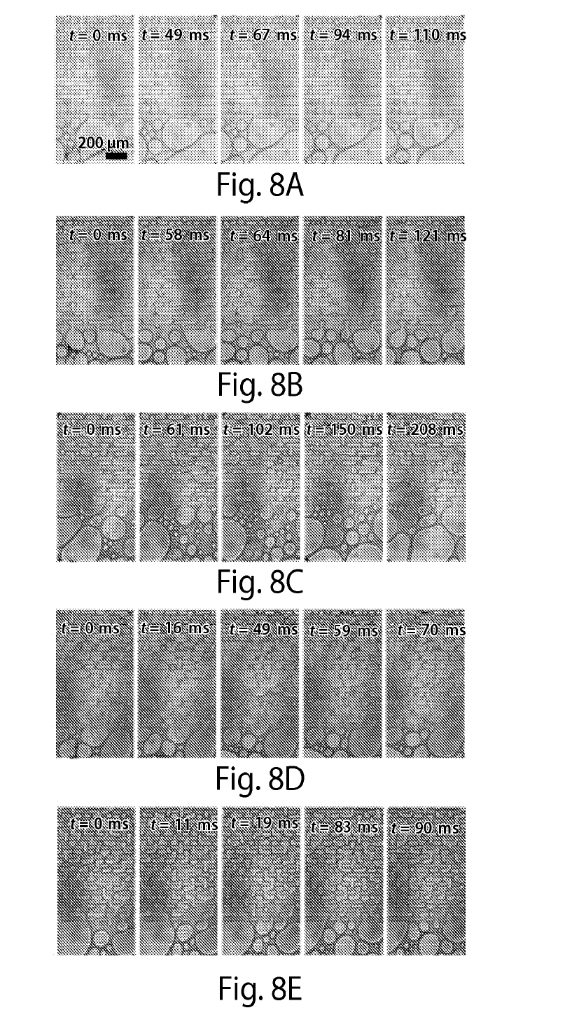

To minimize the possibility of droplets bypassing obstructions without being divided, rectangular obstructions with aspect ratios (i.e., length:width) from 2 to 10 were used. Most of the droplets that were pushed against rectangular obstructions with an aspect ratio of 2 were observed to divide. Typically, a droplet was divided into two daughter droplets (i.e., divided droplets), which could be of the same or different sizes. As shown in FIG. 8, division typically occurred at the edges of these obstructions in a similar manner to division at square obstructions. Droplets that were pushed against rectangular obstructions with an aspect ratio of at least 3 were divided into multiple droplets (i.e., each droplet was divided into more than two divided droplets).

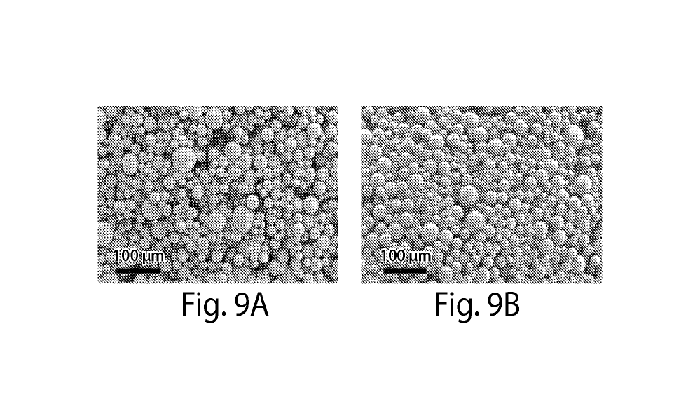

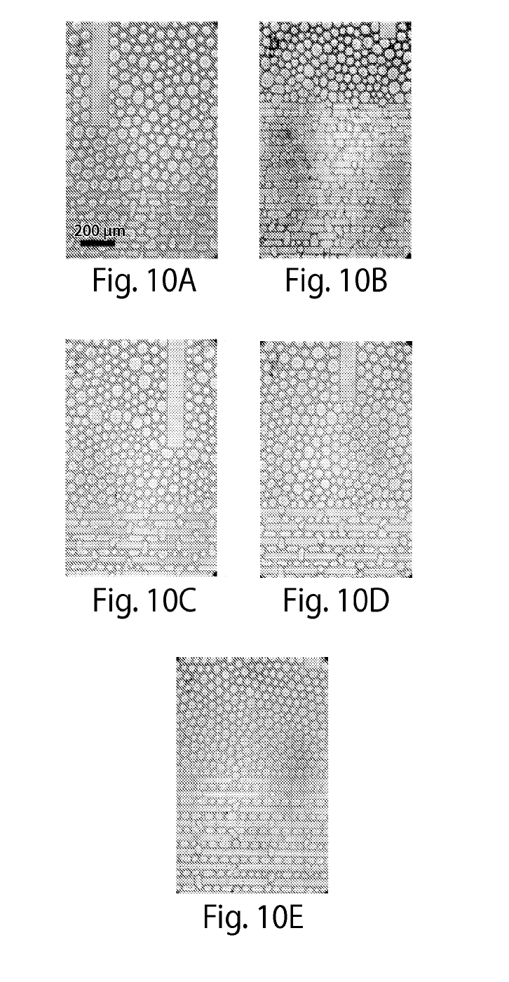

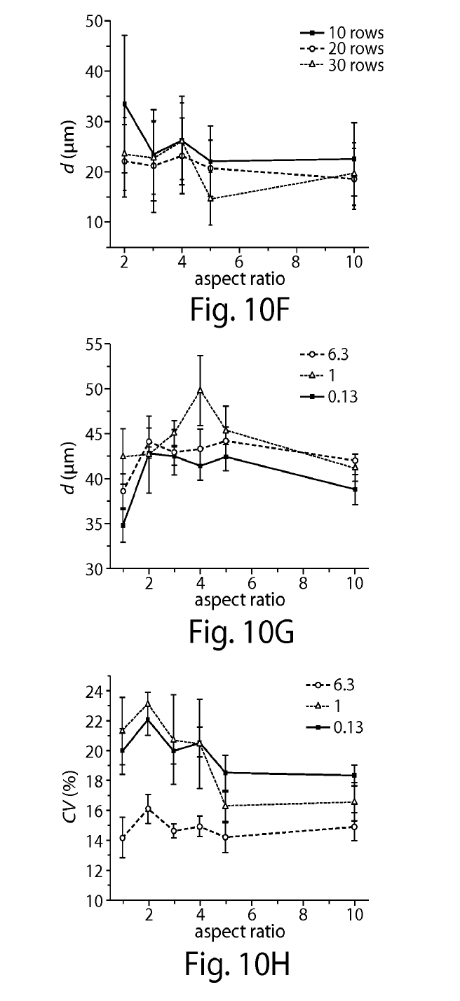

The division of droplets typically occurred in the center of the obstructions where the droplets were forced to change the flow direction, e.g., by 90°. The division of droplets in these devices was accelerated by subsequent droplets that were pushed across the same junction. These subsequent droplets increased the pressure drop across the first droplet and accelerate its “necking” which resulted in an accelerated division of the first droplet as shown in FIG. 8. Thus, the polydispersity of droplets decreased with increasing volume fraction of the dispersed phase as shown in FIG. 9. For emulsions with eta_{dispersed}/eta_{continuous} (η_{dispersed}/η_{continuous}) less than 6.5, the polydispersity of droplets decreased with increasing aspect ratio of the obstructions for the emulsions in these experiments, as shown in FIG. 10. By contrast, the polydispersity increased with increasing aspect ratio if the viscosity of the dispersed phase was significantly above the viscosity of the continuous phase as shown in FIG. 11. For devices in which the viscosity of the dispersed phase was significantly above the viscosity of the continuous phase, an insufficient pressure drop occurred across the droplets. The insufficient pressure drop led to less necking of the droplets and therefore an inefficient break-up which translated into a high polydispersity.

FIGS. 8A-E show optical micrographs of microfluidic devices that contain rectangular obstructions. The aspect ratios of the rectangular obstructions were: a) 10, b) 5, c) 4, d) 3, and e) 2. In these experiments, a water-in-oil emulsion containing 60 vol % water was delivered through these devices at a rate of 5 ml/h.

FIGS. 9A-B shows scanning electron microscope (SEM) images of poly(dimethyl siloxane) (PDMS)-based micro-particles produced using devices containing 20 rows of obstructions. The obstructions were rectangular with an aspect ratio of 10. The crude emulsion contained a) 60 vol % and b) 80 vol % dispersed phase and was injected into the device at a flow rate of 50 ml/h.

FIGS. 10A-H shows optical micrographs of the outlet of the microfluidic devices that contained rectangular obstructions. The aspect ratios of the rectangular obstructions were a) 2, b) 3, c) 4, d) 5, and e) 10. A water-in-oil emulsion containing 60 vol % water was delivered through these devices at a rate of 5 ml/h. FIG. 10F shows a graph of the average size of the droplets produced with microfluidic devices that contained rectangular obstructions as a function of the aspect ratio of the rectangular obstructions. FIGS. 10G-H show graphs of average diameter of the droplets versus aspect ratio and coefficient of variation of the droplets versus aspect ratio, respectively, for ratios of the viscosity of the dispersed phase to the viscosity of the continuous phase.

FIGS. 11A-F shows SEM images of PDMS-based microparticles produced with the microfluidic devices containing 20 rows of obstructions. The rectangular obstructions had aspect ratios of a) 1, b) 2, c) 3, d) 4, e) 5, and f) 10. The fraction of dispersed phase in the emulsion was 60 vol % and the emulsion was injected into the devices at a flow rate of 50 ml/h.

### Example 5

This example describes the effect of array configuration on final droplet size and throughput. The distance between adjacent obstructions in a row was found to influence the number of rows required to ensure droplets reached their characteristic dimension (i.e., the size where droplets could typically pass through the array of obstructions without further alteration). The number of columns in the array was found to be directly proportional to the throughput of the device.

In the microfluidic devices used in this example, large droplets are divided multiple times until all the resulting droplets were small enough to pass obstructions without substantial further alterations (i.e., reaching their characteristic dimension, such that additional rows of obstructions did not substantially alter the average size of the droplets passing through). Thus, to ensure completion of droplet division, the devices had to possess a minimum amount of rows of obstructions. The number of obstructions required to break droplets into their characteristic dimension was found to increase with decreasing spacing between adjacent obstructions in these experiments. Devices with obstructions that were between 20 micrometers and 40 micrometers apart required a minimum of 20 rows to ensure complete break-up of all the droplets of the crude emulsion into their characteristic dimensions. Additional rows of obstructions beyond 20 rows did not substantially further alter the average size of the droplets. However, the pressure drop across the devices linearly increased with increasing number of rows of obstructions. Thus, increasing the number of rows of obstructions beyond 20 rows increased the pressure drop within the device without substantially affecting the size of the droplets that were produced. Thus, there exists an optimum of number of rows of obstructions for a given spacing between adjacent obstructions in these particular experiments. For example, for these devices that were 40 micrometers tall with obstructions that were 20 micrometers to 40 micrometers apart, the optimum was about 20 rows of obstructions. However, other factors may also be important in other embodiments for determining an optimum number of rows of obstructions, in other devices.

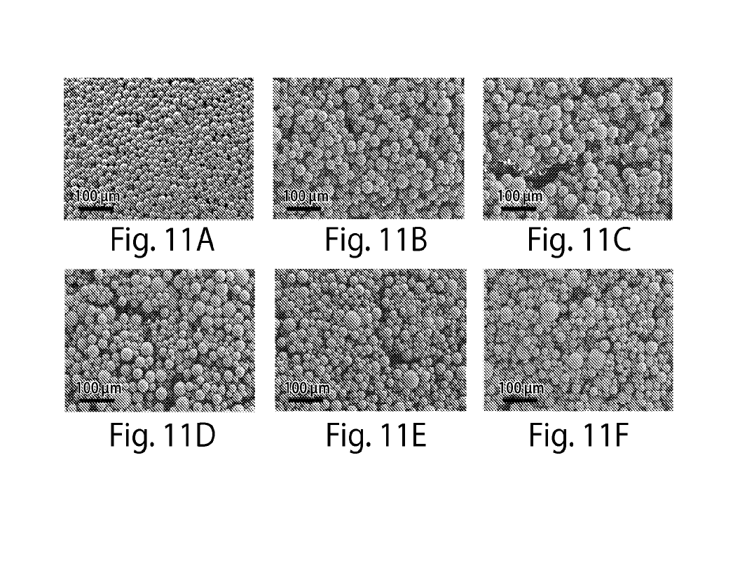

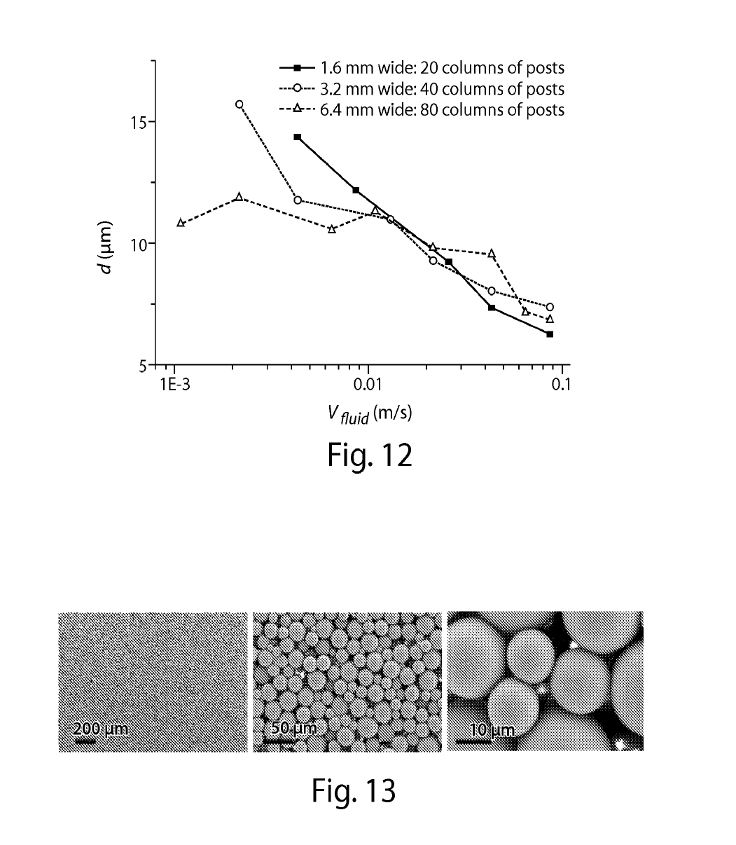

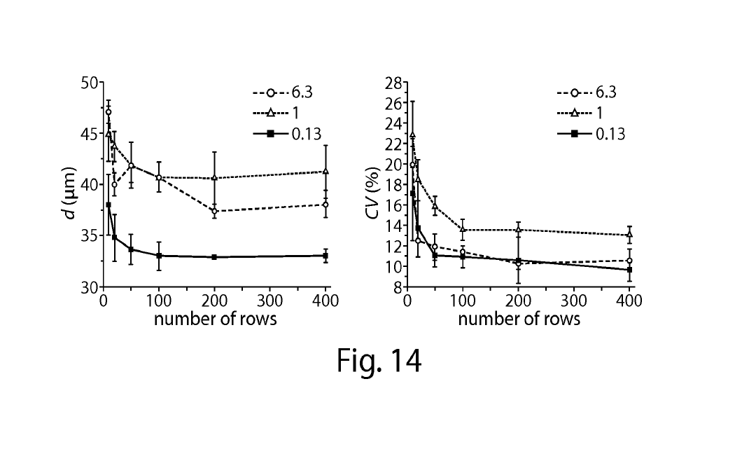

The number of columns and rows in the array also influenced the throughput of the device, e.g., due to the relationship between capillary number and average fluid velocity. The capillary number linearly increased with increasing velocity of the fluid through the array of obstructions. If the viscosity of the dispersed phase was on the order of that of the continuous phase or lower, the size of the droplets was found to decrease with increasing velocity of the fluid as shown in FIG. 12. FIG. 12 shows the size of droplets as a function of the velocity at which the emulsion was delivered through microfluidic devices with square obstructions. These devices contained different numbers of columns of obstructions as indicated in the FIG. 12 legend. The decrease in droplet size with increasing fluid velocity allowed for good control over the average size of droplets. However, more importantly, the decrease in droplet size with increasing fluid velocity means that these devices are potentially scalable. The velocity of the fluid within the device was also found to be proportional to its flow rate and the total area of interstitial spaces at each cross-section of the device. Thus, the flow rate at which the emulsion was injected into the device and therefore the throughput was found to be directly proportional to the number of columns in the device. The throughput can therefore be increased by designing devices with an increasing number of rows of obstructions without substantially altering the velocity of the fluid in the device as shown in FIG. 13. FIG. 14 shows the size of the droplets and the coefficient of variation of the droplets as a function of the number of rows.

### Example 6

This example describes a scaled-up version of the device and the production of polymeric microparticles at a high throughput in the devices. The scaled-up version had 5 parallelized microfluidic devices. Polymeric microparticles were produced using photo-polymerization techniques such as those described in Example 2 and had diameters ranging from 15 to 25 micrometers with a polydispersity of 20-25%.

As an example of the ability to scale up these devices, five parallelized devices each containing 500 columns and 20 rows of obstructions were designed. The obstructions were 40 micrometers tall; adjacent columns of obstructions were 40 micrometers apart, and the spacing between adjacent rows of obstructions was 20 micrometers in these experiments. To ensure equal flow rates throughout the entire scaled-up device, the pressure drop inside the distribution channel was minimized. The pressure drop was proportional to the smallest dimension of the channel cubed in these experiments. Therefore, the distribution channel was designed to be 140 micrometer tall and 1.9 mm wide as shown in FIG. 3. In these devices, the pressure drop across the distribution channel was 85 times smaller than that across the array of obstructions and was therefore negligible. FIG. 3 shows a schematic illustration of five parallelized microfluidic devices. The parts of the devices containing obstructions 20 (which appear solid in this figure, although they are actually separate obstructions when viewed closely as is shown in the inset in FIG. 3) were 40 micrometers tall and the other portions of the device, corresponding to the inlet and outlet of the devices, were 140 micrometers tall.

To test the ability of these devices to produce polymeric microparticles at a high throughput, crude oil in water (O/W) emulsions where the oil phase was a methacrylate based siloxane monomer containing 1 wt % 2-hydroxy-2-methyl-1-phenyl-1-propanone as a photoinitiator were assembled. The oil phase was mixed with an aqueous phase containing 10 wt % poly(vinyl alcohol) (PVA) as a surfactant; the oil phase served as the continuous phase. The crude emulsion was delivered through the microfluidic device at a flow rate of 25 ml/h. Polymerization of the droplets was initiated after the emulsion exited the device by constantly illuminating the polyethylene tubing that connected the outlet of the device with the collection vial with UV light. The particles were collected in a glass vial and stored at room temperature for at least 12 h to ensure complete polymerization of the methacrylate based siloxane monomer. The polymerized particles were washed and optionally dried. The particles were found to have diameters ranging from 15 to 25 micrometers with a polydispersity of 20-25% as can be seen in FIG. 13. While the resulting particles were more polydisperse than those produced with conventional microfluidic devices, their size distribution was below that achieved with conventional membrane filtration methods. These microfluidic devices therefore were well suited for applications that require large amounts of microparticles of a certain average size but can tolerate some degree of polydispersity. The simplicity of these devices allowed robust operation, e.g., the devices could be run continuously for 24 hours a day without the need for constant monitoring; this feature is particularly attractive for certain industrial applications.

FIG. 13 shows scanning electron microscope (SEM) images of PDMS-based particles produced with a microfluidic device with 382 columns of square obstructions. The crude emulsion was injected at a rate of 25 ml/h.

### Example 7

This example describes certain experimental details for Examples 1-6.

The microfluidic devices were fabricated using known soft lithography techniques. Briefly, masks were designed using AutoCAD and printed with a resolution of 20,000 dpi. The master was formed two layers of photoresist: the first layer was 40 micrometers thick and included the array of obstructions as well as the inlet and outlet channels. The second layer, which was aligned with the first layer, included the inlet and outlet channels only. The second layer was 100 micrometers thick and reduced the pressure drop across these channels. Replicas were made from these masters using PDMS that was mixed at a weight ratio of base to crosslinker of 10 to 1. The PDMS replica was bonded to glass slides using an O₂ plasma. To form water-in-oil emulsions, PDMS devices were rendered hydrophobic by treating them with water repellant (e.g., Aquapel). To form oil in water emulsions, the surface of PDMS device was rendered hydrophilic through the deposition of poly(diallyldimethylammonium chloride) (M_{w}=400-500 kDa) polyelectrolytes.

The aqueous phase of oil in water emulsions used 10 wt % poly(vinyl alcohol) (PVA) as a surfactant. The oil phase of water-in-oil emulsion contained 1 wt % of a perfluorinated surfactant. Crude emulsions were formed by mixing 60 vol % of the dispersed with 40 vol % of the continuous phase and mechanically agitating it. The resulting crude emulsion was injected into the microfluidic device through polyethylene tubing using volume controlled syringe pumps.

The interface tension of the different types of emulsions was measured using the pendant drop method. The viscosity of the different components of the emulsions was measured on an Anton Paar rheometer (Physica MCR). To acquire SEM images of PDMS based micro-particles, these particles were dried in air and subsequently coated with a thin layer of Pt/Pd to avoid charge build-up during electron microscopy analysis. SEM was performed on a Supra55 (Zeiss) operated at an acceleration voltage of 5 kV. Images were detected using a secondary electron detector.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimension, materials, and configurations described herein are meant to be exemplary and that the actual parameters, dimension, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, device, article, material, kit, and/or method described herein. In addition, any combination of two or more such features, devices, articles, materials, kits, and/or methods, if such features, devices, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An article, comprising:
a microfluidic channel comprising a two-dimensional array of obstructions therein, arranged in a plurality of rows of substantially regularly-spaced obstructions, the rows arranged substantially orthogonal to a direction of average fluid flow through the microfluidic channel,
wherein at least some of the rows of substantially regularly-spaced obstructions are offset relative to an adjacent row of substantially regularly-spaced obstructions.

2. The article of claim 1, wherein the average horizontal spacing between an obstruction and a next nearest obstruction in the rows of the array is greater than or equal to about 10 micrometers and less than about 100 micrometers.

3. The article of any one of claims 1 or 2, wherein the average vertical spacing between an obstruction and a next nearest obstruction in the columns of the array is greater than or equal to about 10 micrometers and less than about 100 micrometers.

4. The article of any one of claims 1-3, wherein the centers of the obstructions in at least some of the rows are offset relative to the centers of the obstructions in an adjacent row.

5. The article of claim 4, wherein the centers of the obstructions in at least some of the rows are offset relative to the centers of the obstructions in an adjacent row by less than or equal to about 100 micrometers.

6. The article of any one of claims 1-5, wherein the array of obstructions comprises at least 5 rows and less than 100 rows of obstructions.

7. The article of any one of claims 1-6, wherein at least some of the obstructions have a portion that is at a 90° angle with respect to an average direction of fluid flow in the microfluidic channel.

8. The article of any one of claims 1-7, wherein at least some of the obstructions are substantially rectangular.

9. The article of any one of claims 1-8, wherein at least some of the obstructions are substantially square.

10. The article of any one of claims 1-9, wherein at least some of the obstruction are substantially circular.

11. The article of any one of claims 1-10, wherein the average height of the obstructions is less than about 100 micrometers.

12. The article of any one of claims 1-11, wherein the average width of the obstructions is less than about 100 micrometers.

13. The article of any one of claims 1-12, wherein the average aspect ratio of the obstructions is at least 2.

14. The article of any one of claims 1-13, wherein the average aspect ratio of the obstructions is less than about 10.

15. The article of any one of claims 1-14, wherein the average interstitial volume of the array is less than or equal to about 200,000 cubic micrometers.

16. An article, comprising:
a microfluidic channel comprising a two-dimensional array of obstructions therein, arranged in a plurality of rows of obstructions, the rows arranged substantially orthogonal to a direction of average fluid flow through the microfluidic channel,
wherein at least about 90% of imaginary lines drawn through the array of obstructions in the direction of average fluid flow through the microfluidic channel intersects obstructions of at least about 40% of the rows of obstructions forming the array.

17. An article, comprising:
a microfluidic channel comprising an array of obstructions therein, arranged such that no flow path of fluid from upstream entering the array of obstructions exits downstream of the array without at least five changes in direction.

18. A method, comprising:
providing a two-dimensional array of obstructions contained within a microfluidic channel, wherein the average distance between an obstruction and the next nearest obstruction is less than about 1 mm; and
passing a plurality of droplets through the array of obstructions to divide at least about 50% of the droplets to form a plurality of divided droplets.

19. The method of claim 18, wherein substantially all of the droplets are divided to form the plurality of divided droplets.

20. The method of any one of claims 18 or 19, wherein the plurality of divided droplets has a coefficient of variation of the characteristic dimension is less than or equal to about 20%.

21. The method of any one of claims 18-20, wherein the coefficient of variation of the characteristic dimension of each of the plurality of droplets is greater than the coefficient of variation of the characteristic dimension of each of the plurality of divided droplets.

22. The method of any one of claims 18-21, wherein at least about 70% of the droplets are divided to form the plurality of divide droplets.

23. The method of any one of claims 18-22, wherein at least about 90% of the droplets are divided to form the plurality of divide droplets.

24. The method of any one of claims 18-23, wherein the droplets are contained within a liquid.

25. The method of any one of claims 18-24, wherein the ratio of the viscosity of the droplets to the viscosity of the liquid is less than or equal to about 20.

26. The method of any one of claims 18-25, wherein the capillary number of the droplets is less than about 2.

27. A method, comprising:
applying shear forces to a plurality of droplets by passing the plurality of droplets through a two-dimensional array of obstructions such that the droplets are divided to form a plurality of divided droplets, wherein the plurality of divided droplets has a distribution in characteristic dimension such that no more than about 5% of the divided droplets have a characteristic dimension greater than about 120% or less than about 80% of the average characteristic dimension of the plurality of divided droplets.

28. The method of claim 27, wherein the shear stress is greater than or equal to about 0.01 Pa and less than about 3 Pa.

29. A method, comprising:
passing a droplet through a two-dimensional array of obstructions contained within a microfluidic channel to divide the droplet to form a plurality of divided droplets.
